(19) United States
(12) Patent Application Publication
(10) Pub. No.: US 2026/0192253 A1
(43) Pub. Date: Jul. 9, 2026

(54) CATALYST COMPRISING A SULFUR-TRAP MATERIAL FOR THE TREATMENT OF AN EXHAUST GAS STREAM CONTAINING ONE OR MORE OF FORMALDEHYDE, NITROGEN OXIDE (NO), AND HYDROCARBONS

(71) Applicant: BASF MOBILE EMISSIONS CATALYSTS LLC, lselin, NJ (US)

(72) Inventors: Jeffrey B HOKE, Iselin, NJ (US); Shiang SUNG, Iselin, NJ (US); Pascaline TRAN, Iselin, NJ (US); Yipeng SUN, Iselin, NJ (US); Yuejin LI, Iselin, NJ (US)

(21) Appl. No.: 19/131,142

(22) PCT Filed: Dec. 4, 2023
(86) PCT No.: PCT/EP2023/084136

§ 371 Date: May 19, 2025

(30) Foreign Application Priority Data
Dec. 2, 2022 (EP) 22211063.7

(51) Int. Cl. B01D 53/94; B01D 53/04; B01J 23/42; B01J 23/83; B01J 37/02

(52) U.S. Cl. CPC B01D 53/9459; B01D 53/04; B01D 53/9481; B01J 23/42; B01J 23/83; B01J 37/0244; B01D 2253/1124; B01D 2255/1021; B01D 2255/20761; B01D 2255/9022; B01D 2255/9025; B01D 2255/9027; B01D 2255/904; B01D 2255/912; B01D 2257/404; B01D 2257/70; B01D 2258/012

(57) ABSTRACT

A catalyst for the treatment of an exhaust gas stream containing one or more of formaldehyde, nitrogen oxide (NO), and hydrocarbons, the catalyst comprising a first washcoat layer comprising Mn, a second washcoat layer comprising a sulfur-trap material, and a substrate, wherein the substrate has an inlet end and an outlet end, wherein the exhaust gas stream flowing through the catalyst first comes into contact with the second washcoat layer prior to coming into contact with the first washcoat layer, wherein the catalyst further comprises one or more platinum group metals comprising Pt, Pd, or Pt and Pd, wherein the one or more platinum group metals are at least in part contained in one or more of (a) the first washcoat layer, (b) the second washcoat layer, and (c) an optional third washcoat layer.

### TECHNICAL FIELD

The present invention relates to a catalyst for the treatment of an exhaust gas stream containing one or more of formaldehyde, nitrogen oxide (NO), and hydrocarbons, an exhaust gas treatment system comprising said catalyst, a method for the treatment of an exhaust gas stream containing one or more of formaldehyde, nitrogen oxide (NO), and hydrocarbons using said catalyst, and use of said catalyst for the oxidation of one or more of formaldehyde, nitrogen oxide (NO), and hydrocarbons.

### INTRODUCTION

The present invention relates to a diesel oxidation catalyst (DOC) with enhanced oxidation function, in particular with enhanced oxidation function of one or more of formaldehyde (HCHO), nitrogen oxide (NO), and hydrocarbons (including diesel fuel). It is known that formaldehyde is a toxic material that is coming under increasing regulation within indoor air spaces due to its release from various building materials used in the construction industry. Tighter regulations are also being implemented for formaldehyde emissions from the engine exhaust of passenger and delivery vehicles. Generally, manganese oxides (e.g., MnO₂) are known to be active for destroying formaldehyde under ambient conditions, but they do not have the required thermal stability to survive in a typical engine exhaust environment. In particular, phase transitions at high temperature (e.g., higher than 400° C.) can cause the structure of MnO₂ to collapse such that the surface area and pore volume are so low as to be catalytically ineffective. One way to improve the stability of the Mn oxide at high temperature (as well as other catalytically useful base metal oxides such as copper, ceria and iron) can be to support them on refractory oxide materials which themselves have high stability when exposed to high temperatures in the engine exhaust. Materials such as aluminum oxide (Al₂O₃) and zirconium oxide (ZrO₂) can be useful in this regard.

The key challenge for inclusion of Mn-containing base metal oxide (BMO) catalysts in technology for abatement of exhaust emissions from diesel vehicles can be seen in the intrinsically poor S resistance of Mn reflected in the high desulfation temperature of manganese sulfate. As described in the literature, significant desulfation of MnSO₄ does not occur at temperatures typical for filter regeneration or de-sulfation (de-SOx) on a diesel engine (about 650-700° C.). In flowing nitrogen, 800° C. is typically required, while in flowing air, the temperature is even about 30° C. higher (FIG. 1).

It is known that Pt and Pd supported on a high temperature resistant refractory metal oxide support provides efficient oxidation of CO and HC pollutants emitted from diesel engines. Such DOC compositions are needed by vehicle manufacturers to meet ever more stringent worldwide CO and HC exhaust emission requirements. An additional function of the DOC composition when placed in the exhaust of a diesel vehicle is to oxidize diesel fuel injected into the exhaust upstream of the DOC in order to create a high temperature exotherm that is used to thermally oxidize soot that has accumulated on a diesel particulate filter (DPF) or a catalyzed soot filter (CSF) located downstream of the DOC composition. Alternatively, the hydrocarbon concentration in the exhaust stream can be increased for exotherm generation by adjusting the combustion process through various post-injection methods or the like. Temperatures greater 600° C. at the DPF or CSF inlet are preferred to provide efficient oxidation of the retained soot. The concentration of diesel fuel injected into the exhaust stream needed to provide the desired exotherm is quite high, approximately 1% (10,000 ppm) on a C1 basis or more. The temperature at which the DOC composition can oxidize (“light-off”) the injected fuel needs to be as low as possible, preferably less than 300° C. In addition, the amount of hydrocarbon slip bypassing the DOC catalyst during exotherm generation needs to be as low as possible, preferably less than 3,000 ppm, 2,000 ppm or even 1,000 ppm.

WO 2022/047132 A1 relates to an oxidation catalyst composition for catalytic articles, and exhaust gas treatment systems for reducing formaldehyde levels in engine exhaust emissions. In particular, an oxidation catalyst is disclosed in claim 1 comprising a platinum group metal (PGM) component comprising Pd, Pt, or a combination thereof, a manganese component, and a first refractory metal oxide support material comprising zirconia.

U.S. Pat. No. 10,598,061 B2 relates to methods and systems for a diesel oxidation catalyst. In particular, a method is disclosed in claim 1 comprising: generating NO₂ in a catalyst comprising a washcoat with zirconium, one or more base metal oxides, and a palladium oxide, with an exhaust gas flow rate being between lower and upper threshold flow rates; and facilitating a regeneration of a particulate filter located downstream of the catalyst via NO₂ when an exhaust gas temperature is greater than a threshold temperature where the palladium oxide is contained in an upstream portion of the catalyst relative to a direction of exhaust gas flow; and the one or more base metal oxides are contained in a downstream portion of the catalyst relative to the direction of exhaust gas flow.

U.S. Pat. No. 10,392,980 B2 relates to methods and systems for a diesel oxidation catalyst. In particular, a method is disclosed in claim 1 comprising: passing diesel combustion exhaust gas over a diesel oxidation catalyst having a washcoat comprising zirconium oxide, palladium oxide, and at least one base metal oxide, the washcoat coated on a surface of a substrate with the at least one base metal oxide coated to a downstream portion of the substrate in a greater amount than coated to an upstream portion and the palladium oxide coated to the upstream portion of the substrate in a greater amount than coated to the downstream portion, downstream referring to an axial direction of exhaust gas flow, and where the palladium oxide is 0.5-3 weight percent of the washcoat.

US 2015/352493 A1 relates to a catalytic article comprising a first catalytic coating comprising a platinum group metal, wherein the first catalytic coating is substantially free of Cu, Ni, Fe, Mn, V, Co, Ga, Mo, Mg, Cr and Zn; a second catalytic coating comprising a non-PGM metal, wherein the second catalytic coating is substantially free of a platinum group metal; and one or more substrates, wherein the first catalytic coating is separated from the second catalytic coating.

US 2022/152589 A1 relates to a composite oxidation catalyst for use in an exhaust system for treating an exhaust gas produced by a vehicular compression ignition internal combustion engine and upstream of a particulate matter filter in the exhaust system.

CN 112 805 089 A discloses a three-way catalyst composition comprising alumina doped with a transition metal. The transition metal comprises Ti, Mn, Fe, Cu, Zn, Ni, or a combination thereof.

Therefore, it was an object of the present invention to provide a catalyst having an improved performance with respect to the conversion of one or more of formaldehyde, nitrogen oxide (NO), and hydrocarbons, in particular after being exposed to a sulfation and de-sulfation treatment.

### DETAILED DESCRIPTION

It has surprisingly been found that an improved catalyst can be provided for the conversion of one or more of formaldehyde, nitrogen oxide (NO), and hydrocarbons in an exhaust gas. In particular, it has been surprisingly found that a catalyst can be provided showing an improved performance with respect to the conversion of one or more of formaldehyde, nitrogen oxide (NO), and hydrocarbons after being exposed to a sulfation and de-sulfation treatment as encountered in a typical application. Furthermore, it has been surprisingly found that the catalyst according to the present invention shows enhanced hydrocarbon (HC) and nitrogen oxide (NO) oxidation function. In particular, it has surprisingly been found that the benefit of using BMO-containing catalyst to reduce platinum group metal in diesel exhaust treatment systems is not limited only to HCHO oxidation, but also to hydrocarbon and NO oxidation. This enables vehicle manufacturers to meet ever tightening vehicle emissions standards while also reducing overall PGM usage and costs. It has also been surprisingly found that use of a diesel oxidation catalyst (DOC) comprising both a platinum group metal (PGM) and a base metal oxide (BMO) catalyst leads to a catalyst having enhanced fuel burning function. Furthermore, it can be expected that the catalyst of the present invention is able to oxidize soot accumulation on a substrate, in particular on a wall-flow substrate, especially since the Mn-containing washcoat layer can generate NO₂ which oxidizes soot. Additionally, the catalyst of the present invention can enable a comparatively lower N₂O production, in particular due to its comparatively lower content of platinum group metals.

Therefore, the present invention relates to a catalyst for the treatment of an exhaust gas stream containing one or more of formaldehyde, nitrogen oxide (NO), and hydrocarbons, the catalyst comprising
a first washcoat layer comprising Mn,
a second washcoat layer comprising a sulfur-trap material which may be desulfated, and
a substrate,
wherein the substrate preferably has an inlet end through which the exhaust gas stream may enter the catalyst, and an outlet end through which the exhaust gas stream may exit the catalyst, wherein the exhaust gas stream flowing through the catalyst preferably first comes into contact with the second washcoat layer prior to coming into contact with the first washcoat layer,
wherein the catalyst further comprises one or more platinum group metals comprising Pt, Pd, or Pt and Pd, wherein the one or more platinum group metals are at least in part contained in one or more of:
(a) the first washcoat layer,
(b) the second washcoat layer, and
(c) an optional third washcoat layer, or
(d) optional third and fourth washcoat layers.

Within the meaning of the present invention, the sulfur-trap material may reversibly bind sulfur in the form of a sulfate and/or sulfite, wherein the regeneration of the material leads to the release of sulfur, in particular as SO₂ and/or SO₃ in a process which is designated as desulfation.

It is preferred that the second washcoat layer is substantially free of Mn, wherein more preferably the optional second washcoat layer is free of Mn. It is noted that Mn contained in the second washcoat layer may result from the leaking thereof into said layer from another layer containing Mn, in particular from the first washcoat layer.

Within the meaning of the present invention, a washcoat layer is substantially free of an element or compound(s) when the washcoat layer contains said element or compound(s) in an amount of 1 wt.-% or less calculated as the element or compound(s) and based on 100 wt.-% of the washcoat layer, preferably in an amount of 0.5 wt.-% or less, more preferably of 0.1 wt.-% or less, more preferably of 0.05 wt.-% or less, more preferably of 0.01 wt.-% or less, more preferably of 0.005 wt.-% or less, and more preferably of 0.001 wt.-% or less.

It is preferred that the first washcoat layer is substantially free of a sulfur-trap material, wherein more preferably the first washcoat layer is free of a sulfur-trap material.

It is preferred that the first washcoat layer is substantially free of the one or more platinum group metals, wherein preferably the first washcoat layer is free of the one or more platinum group metals.

It is preferred that the loading of Mn, calculated as the element, in the first washcoat layer is in the range of from 1 to 50 wt.-% based on 100 wt.-% of the first washcoat layer, more preferably from 2 to 30 wt.-%, more preferably from 5 to 20 wt.-%, more preferably from 8 to 12 wt.-%.

It is preferred that Mn is present in the form of one or more cations of Mn, wherein Mn is more preferably contained in the first washcoat layer as one or more oxides, wherein Mn is more preferably contained in the first washcoat layer as one or more oxides of Mn(II), Mn(III), Mn(II/III), and Mn(IV), more preferably as one or more oxides selected from the group consisting of MnO, Mn₂O₃, Mn₃O₄, MnO₂, Mn(O)OH, and Mn-Zr mixed oxides, including mixtures of two or more thereof, wherein the Mn-Zr mixed oxides are preferably contained in the first washcoat layer as a solid solution.

It is preferred that the first washcoat layer comprises a particulate support material, wherein Mn is supported on the particulate support material, wherein the particulate support material is more preferably selected from the group consisting of ZrO₂, Al₂O₃, SiO₂, TiO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, praseodymium oxide-doped CeO₂—ZrO₂ mixed oxide, ZrO₂-doped Al₂O₃, ZrO₂-doped SiO₂, SiO₂-doped Al₂O₃, CuO—Al₂O₃ mixed oxide, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, PrO₂-doped CeO₂—ZrO₂ mixed oxide, ZrO₂-doped Al₂O₃, ZrO₂-doped SiO₂, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, and mixtures of two or more thereof, wherein more preferably Mn is supported on particulate La₂O₃-doped ZrO₂.

It is preferred that the first washcoat layer comprises Ce, wherein Ce is more preferably contained in the first washcoat layer as CeO₂ and/or Ce₂O₃.

In the case where the first washcoat layer comprises Ce, it is preferred that the loading of Ce, calculated as the element, in the first washcoat layer is in the range of from 1 to 50 wt.-% based on 100 wt.-% of the first washcoat layer, more preferably from 2 to 30 wt.-%, more preferably from 5 to 20 wt.-%, more preferably from 8 to 12 wt.-%.

Further in the case where the first washcoat layer comprises Ce, it is preferred that Ce is supported on a particulate support material, wherein the particulate support material is preferably selected from the group consisting of ZrO₂, Al₂O₃, SiO₂, TiO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, praseodymium oxide-doped CeO₂—ZrO₂ mixed oxide, ZrO₂-doped Al₂O₃, ZrO₂-doped SiO₂, SiO₂-doped Al₂O₃, CuO—Al₂O₃ mixed oxide, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, PrO₂-doped CeO₂—ZrO₂ mixed oxide, ZrO₂-doped Al₂O₃, ZrO₂-doped SiO₂, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, and mixtures of two or more thereof, wherein more preferably Ce is supported on particulate La₂O₃-doped ZrO₂.

It is preferred that the first washcoat layer comprises Cu, wherein the first washcoat layer preferably comprises CuO, Cu₂O, or CuO and Cu₂O, more preferably CuO.

In the case where the first washcoat layer comprises Cu, it is preferred that the loading of Cu, calculated as the element, in the first washcoat layer is in the range of from 1 to 50 wt.-% based on 100 wt.-% of the first washcoat layer, more preferably from 2 to 30 wt.-%, more preferably from 5 to 20 wt.-%, more preferably from 8 to 12 wt.-%.

Further in the case where the first washcoat layer comprises Cu, it is preferred that Cu is supported on a particulate support material, wherein the particulate support material is more preferably selected from the group consisting of ZrO₂, Al₂O₃, SiO₂, TiO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, praseodymium oxide-doped CeO₂—ZrO₂ mixed oxide, ZrO₂-doped Al₂O₃, ZrO₂-doped SiO₂, SiO₂-doped Al₂O₃, CuO—Al₂O₃ mixed oxide, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, PrO₂-doped CeO₂—ZrO₂ mixed oxide, ZrO₂-doped Al₂O₃, ZrO₂-doped SiO₂, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, and mixtures of two or more thereof, wherein more preferably Cu is supported on particulate La₂O₃-doped ZrO₂.

It is preferred that the loading of the sulfur-trap material in the second washcoat layer is in the range of from 5 to 100 wt.-% based on 100 wt.-% of the second washcoat layer, more preferably from 10 to 95 wt.-%, more preferably from 20 to 90 wt.-%, more preferably from 30 to 80 wt. %, more preferably from 40 to 70 wt.-%.

It is preferred that the sulfur-trap material comprises one or more metal oxides which react with SO₂ and/or SO₃ to form corresponding metal sulfites and/or sulfates, wherein preferably the sulfur-trap material consists of the one or more metal oxides.

In the case where the sulfur-trap material comprises one or more metal oxides which react with SO₂ and/or SO₃ to form corresponding metal sulfites and/or sulfates, it is preferred that each of the one or more metal oxides, which react with SO₂ and/or SO₃ to form corresponding metal sulfite and/or sulfate, displays a desulfation temperature T₅₀, at which 50% of the respective metal sulfite and/or metal sulfate has decomposed to the metal oxide and SO₂ and/or SO₃, which is lower than the desulfation temperature T₅₀ of MnSO₄, wherein more preferably, each of the one or more metal oxides displays a desulfation temperature T₅₀ which is at least 10° C. lower than the desulfation temperature T₅₀ of MnSO₄, preferably at least 20° C. lower, more preferably at least 50° C. lower, more preferably at least 80° C. lower, more preferably at least 100° C. lower, more preferably at least 150° C. lower.

Furthermore and independently thereof, it is preferred that the one or more metal oxides are selected from the group consisting of oxides of Cu, Ni, Co, Fe, Ce, La, Sn, and Zr, including mixtures of two or more thereof, preferably from the group consisting of oxides of Cu, Fe, Ce, La, Sn, and Zr, including mixtures of two or more thereof, more preferably from the group consisting of oxides of Cu, Fe, Sn, La, and Zr, including mixtures of two or more thereof, more preferably from the group consisting of oxides of Cu, Fe, La, and Zr, including mixtures of two or more thereof, wherein more preferably the one or more metal oxides comprise, preferably consist of, oxides of Zr, La, and/or Fe; and/or wherein the one or more metal oxides are preferably selected from the group consisting of oxides of Fe, Cu, and Sn, including mixtures of two or more thereof, more preferably from the list consisting of Fe₂O₃, CuO, and SnO₂, including mixtures of two or more thereof.

Furthermore and independently thereof, it is preferred that the one or more metal oxides comprise, more preferably consist of, oxides of Fe, wherein more preferably the one or more metal oxides comprise, more preferably consist of, Fe₂O₃ and/or Fe₂O₃-doped Al₂O₃; and/or wherein the one or more metal oxides comprise oxides of Fe, wherein the loading of the one or more oxides of Fe in the second washcoat layer is in the range of from 10 to 70 wt.-%, calculated as Fe₂O₃ and based on 100 wt.-% of the second washcoat layer.

In the case where the one or more metal oxides comprise, preferably consist of, oxides of Fe, it is preferred that the loading of the one or more oxides of Fe in the second washcoat layer is in the range of from 1 to 100 wt.-%, calculated as Fe₂O₃ and based on 100 wt.-% of the second washcoat layer, more preferably from 5 to 80 wt.-%, more preferably from 10 to 70 wt.-%, more preferably from 15 to 65 wt.-%, more preferably from 20 to 60 wt.-%, more preferably from 30 to 50 wt.-%, more preferably from 35 to 45 wt.-%. Further in the case where the one or more metal oxides comprise, more preferably consist of, oxides of Fe, it is preferred that the one or more oxides of Fe display an average particle size D50 of 20 μm or less, more preferably of 10 μm or less, more preferably of 5 μm or less, more preferably of 1 μm or less, wherein the average particle size is more preferably determined according to ISO 13320:2020. Further in the case where the one or more metal oxides comprise, more preferably consist of, oxides of Fe, it is preferred that the second washcoat layer comprises one or more oxides selected from the group consisting of Al₂O₃, SiO₂, SiO₂-doped Al₂O₃, and mixtures of two or more thereof, wherein more preferably the second washcoat layer comprises Al₂O₃ and/or SiO₂-doped Al₂O₃, more preferably Al₂O₃.

In the case where the second washcoat layer comprises one or more oxides selected from the group consisting of Al₂O₃, SiO₂, SiO₂-doped Al₂O₃, and mixtures of two or more thereof, it is preferred that the loading of the one or more oxides in the second washcoat layer is in the range of from 0 to 99 wt.-% based on 100 wt.-% of the second washcoat layer, more preferably from 20 to 95 wt.-%, more preferably from 30 to 90 wt.-%, more preferably from 40 to 80 wt.-%, more preferably from 45 to 75 wt.-%, more preferably from 50 to 70 wt.-%, more preferably from 55 to 65 wt.-%.

Further in the case where the sulfur-trap material comprises one or more metal oxides which react with SO₂ and/or SO₃ to form corresponding metal sulfites and/or sulfates, it is preferred that the one or more metal oxides comprise, more preferably consist of, ZrO₂.

In the case where the one or more metal oxides comprise, more preferably consist of, ZrO₂, it is preferred that the loading of ZrO₂ in the second washcoat layer is in the range of from 35 to 100 wt.-% based on 100 wt.-% of the second washcoat layer, more preferably from 45 to 100 wt.-%, more preferably from 75 to 95 wt.-%, more preferably from 85 to 90 wt.-%.

Further in the case where the one or more metal oxides comprise, more preferably consist of, ZrO₂, it is preferred that ZrO₂ is doped with La₂O₃, wherein ZrO₂ and La₂O₃ more preferably form a solid solution.

In the case where ZrO₂ is doped with La₂O₃, it is preferred that ZrO₂ is doped with La₂O₃ in an amount ranging from 1 to 50 wt. % based on 100 wt.-% of ZrO₂ and La₂O₃, more preferably from 3 to 30 wt.-%, more preferably from 5 to 15 wt.-%, more preferably from 8 to 10 wt.-%.

Further in the case where the sulfur-trap material comprises one or more metal oxides which react with SO₂ and/or SO₃ to form corresponding metal sulfites and/or sulfates, it is preferred that the one or more metal oxides comprise CeO₂—ZrO₂ mixed oxide and/or rare earth metal doped CeO₂—ZrO₂ mixed oxide,
wherein the rare earth metal doped CeO₂—ZrO₂ mixed oxide more preferably comprises CeO₂ in an amount in the range of 10 to 95 wt.-%, more preferably in the range of 20 to 90 wt.-%, based on 100 wt.-% of the rare earth metal doped CeO₂—ZrO₂ mixed oxide,
wherein more preferably the CeO₂—ZrO₂ mixed oxide comprises ZrO₂ in an amount in the range of 5 to 75 wt.-%, more preferably in the range of 9 to 70 wt.-%, based on 100 wt.-% of the rare earth metal doped CeO₂-ZrO₂ mixed oxide,
wherein more preferably the rare earth metal doped CeO₂-ZrO₂ mixed oxide further comprises La₂O₃ as dopant, more preferably in an amount in the range of 1 to 10 wt.-%, more preferably in an amount in the range of 1 to 5 wt.-%, more preferably in the range of 2 to 4 wt.-%, based on 100 wt.-% of the rare earth metal doped CeO₂-ZrO₂ mixed oxide,
wherein more preferably the rare earth metal doped CeO₂-ZrO₂ mixed oxide further comprises Y₂O₃ as dopant, more preferably in an amount in the range of 1 to 10 wt.-%, more preferably in an amount in the range of 1 to 5 wt.-%, more preferably in the range of 2 to 4 wt.-%, based on 100 wt.-% of the rare earth metal doped CeO₂-ZrO₂ mixed oxide,
wherein more preferably the rare earth metal doped CeO₂-ZrO₂ mixed oxide further comprises Nd₂O₃ as dopant, more preferably in an amount in the range of 1 to 10 wt.-%, more preferably in an amount in the range of 3 to 7 wt.-%, more preferably in the range of 4 to 6 wt.-%, based on 100 wt.-% of the rare earth metal doped CeO₂-ZrO₂ mixed oxide,
wherein more preferably the rare earth metal doped CeO₂-ZrO₂ mixed oxide further comprises praseodymium oxide, more preferably Pr₂O₃ and/or Pr₆O₁₁, as dopant, more preferably in an amount in the range of 1 to 10 wt.-%, more preferably in an amount in the range of 3 to 7 wt.-%, more preferably in the range of 4 to 6 wt.-%, based on 100 wt.-% of the rare earth metal doped CeO₂-ZrO₂ mixed oxide.

In the case where the one or more metal oxides comprise CeO₂-ZrO₂ mixed oxide and/or rare earth metal doped CeO₂-ZrO₂ mixed oxide, it is preferred that La₂O₃ is supported on the CeO₂-ZrO₂ mixed oxide and/or rare earth metal doped CeO₂-ZrO₂ mixed oxide, more preferably in an amount in the range of 1 to 20 wt.-%, more preferably in an amount in the range of 5 to 15 wt. %, more preferably in the range of 9 to 11 wt.-%, based on 100 wt.-% of the CeO₂-ZrO₂ mixed oxide and/or rare earth metal doped CeO₂-ZrO₂ mixed oxide.

Further in the case where the one or more metal oxides comprise, preferably consist of, ZrO₂, it is preferred that the one or more metal oxides further comprise one or more metal oxides selected from the list consisting of oxides of Fe, Cu, and Sn, including mixtures of two or more thereof, more preferably from the list consisting of Fe₂O₃, CuO, and SnO₂, including mixtures of two or more thereof.

It is preferred that the substrate is a wall-flow substrate or a flow-through substrate, more preferably a honeycomb wall-flow substrate or a honeycomb flow-through substrate, more preferably a honeycomb flow-through substrate, wherein the flow-through substrate is more preferably a flow through substrate with high porosity walls.

It is preferred that the loading of the first washcoat layer is in the range of from 0.5 to 8 g/in³, more preferably of from 0.8 to 7 g/in³, more preferably of from 0.9 to 6 g/in³, more preferably of from 1 to 5 g/in³, more preferably of from 1.5 to 3 g/in³, more preferably of from 2 to 2.5 g/in³.

Within the meaning of the present invention, the loading of a washcoat layer in the catalyst refers to the loading of said washcoat layer based on the volume of the catalyst in which said washcoat layer is contained. Accordingly, within the meaning of the present invention, the loading of a washcoat layer only contained in a certain portion or zone of the catalyst is based on the volume of that portion or zone of the catalyst. Thus, by means of examples, if a washcoat layer is provided over 50% of the axial length of a honeycomb substrate, its loading is calculated based on 50% of the total volume of the honeycomb substrate.

It is preferred that the loading of the second washcoat layer is in the range of from 0.1 to 5 g/in³, more preferably of from 0.25 to 4 g/in³, more preferably of from 0.3 to 3 g/in³, more preferably of from 0.4 to 2.5 g/in³, more preferably of from 0.5 to 2 g/in³, more preferably of from 0.8 to 1.2 g/in³.

It is preferred that the loading of the third washcoat layer is in the range of from 0.25 to 3.0 g/in³, more preferably of from 0.5 to 2.5 g/in³, more preferably of from 1 to 2 g/in³.

It is preferred that the loading of the fourth washcoat layer is in the range of from 0.25 to 3.0 g/in³, more preferably of from 0.5 to 2.5 g/in³, more preferably of from 1 to 2 g/in³.

It is preferred that the catalyst comprises one or more platinum group metals consisting of Pt, Pd, or Pt and Pd, wherein more preferably the catalyst comprises Pt, or Pt and Pd as the one or more platinum group metals, wherein more preferably the catalyst comprises Pt and Pd as the one or more platinum group metals.

It is preferred that the catalyst comprises Pt, calculated as the element, at a loading in the range of from 2 to 250 g/ft³, more preferably of from 5 to 150 g/ft³, more preferably of from 10 to 125 g/ft³, more preferably of from 20 to 100 g/ft³, more preferably of from 25 to 85 g/ft³, more preferably of from 30 to 80 g/ft³, more preferably of from 40 to 60 g/ft³.

Within the meaning of the present invention, the loading of Pt, Pd, or Pt and Pd in the catalyst refers to the loading of Pt, Pd, or Pt and Pd based on the volume of the catalyst in which Pt, Pd, or Pt and Pd is contained. In the event that Pt, Pd, or Pt and Pd is contained in one or more zones of the catalyst, it is preferred within the meaning of the present invention, that the loading of Pt, Pd, or Pt and Pd is based on the volume of the catalyst in which the one or more Pt, Pd, or Pt and Pd zones are contained. Thus, by means of examples, if Pt, Pd, or Pt and Pd is provided in a zone extending over 50% of the axial length of a honeycomb substrate, its loading is calculated based on 50% of the total volume of the honeycomb substrate.

It is preferred that the catalyst comprises Pd, calculated as the element, at a loading in the range of from 1 to 80 g/ft³, more preferably of from 5 to 60 g/ft³, more preferably of from 10 to 50 g/ft³, more preferably of from 15 to 40 g/ft³, more preferably of from 20 to 30 g/ft³. It is preferred that the catalyst comprises Pt and Pd, calculated as the respective element, at a total Pt and Pd loading in the range of from 2 to 250 g/ft³, more preferably of from 5 to 200 g/ft³, more preferably of from 10 to 150 g/ft³, more preferably of from 20 to 130 g/ft³, more preferably of from 30 to 125 g/ft³, more preferably of from 40 to 110 g/ft³, more preferably of from 50 to 100 g/ft³, more preferably of from 60 to 90 g/ft³, more preferably of from 70 to 80 g/ft³.

It is preferred that the catalyst comprises Pt and Pd at a Pt:Pd weight ratio in the range of from 30:70 to 90:10, more preferably of from 50:50 to 80:20, more preferably of from 60:40 to 75:25, more preferably of from 65:35 to 70:30.

It is preferred that the one or more platinum group metals are supported on a particulate support material, wherein the particulate support material is more preferably selected from the group consisting of Al₂O₃, SiO₂, TiO₂, SiO₂-doped Al₂O₃, Mn oxide-doped Al₂O₃, and mixtures of two or more thereof, wherein more preferably the one or more platinum group metals are supported on Al₂O₃ and/or SiO₂-doped Al₂O₃ and/or Mn oxide-doped Al₂O₃, more preferably SiO₂-doped Al₂O₃ or Al₂O₃ or Mn oxide-doped Al₂O₃, wherein the Mn oxide-doped Al₂O₃ preferably comprises from 1 to 10 weight-%, more preferably from 4 to 6 weight-%, of Mn oxide, calculated as MnO₂, based on 100 weight-% of the Mn oxide-doped Al₂O₃.

It is preferred that the catalyst comprises a third washcoat layer, wherein the one or more platinum group metals are at least in part contained in the third washcoat layer, wherein more preferably the one or more platinum group metals are entirely contained in the third washcoat layer.

It is preferred that the third washcoat layer comprises a hydrocarbon trap material, wherein the hydrocarbon trap material comprises a molecular sieve, more preferably a zeolite, more preferably a zeolite having a maximum pore size of 12-membered rings, more preferably zeolite beta.

In the case where the third washcoat layer comprises a hydrocarbon trap material, wherein the hydrocarbon trap material comprises a molecular sieve, it is preferred that the loading of the hydrocarbon trap material in the third washcoat layer is in the range of from 0.01 to 2.0 g/in³, more preferably in the range of from 0.05 to 1.0 g/in³, more preferably in the range of from 0.05 to 0.3 g/in³.

It is preferred that the first washcoat layer comprises a hydrocarbon trap material, wherein the hydrocarbon trap material comprises a molecular sieve, more preferably a zeolite, more preferably a zeolite having a maximum pore size of 12-membered rings, more preferably zeolite beta.

In the case where the first washcoat layer comprises a hydrocarbon trap material, wherein the hydrocarbon trap material comprises a molecular sieve, it is preferred that the loading of the hydrocarbon trap material in the first washcoat layer is in the range of from 0.01 to 2.0 g/in³, more preferably in the range of from 0.05 to 1.0 g/in³, more preferably in the range of from 0.05 to 0.3 g/in³.

It is preferred that the second washcoat layer comprises a hydrocarbon trap material, wherein the hydrocarbon trap material comprises a molecular sieve, more preferably a zeolite, more preferably a zeolite having a maximum pore size of 12-membered rings, more preferably zeolite beta.

In the case where the second washcoat layer comprises a hydrocarbon trap material, wherein the hydrocarbon trap material comprises a molecular sieve, it is preferred that the loading of the hydrocarbon trap material in the second washcoat layer is in the range of from 0.01 to 2.0 g/in³, more preferably in the range of from 0.05 to 1.0 g/in³, more preferably in the range of from 0.05 to 0.3 g/in³.

In the case wherein one or more of the first, second and third washcoat layers comprises a hydrocarbon trap material, it is preferred that independently from one another the hydrocarbon trap material comprises a molecular sieve, more preferably a zeolite, wherein the molecular sieve, more preferably the zeolite, comprises SiO₂ and Al₂O₃, wherein the molecular sieve, more preferably the zeolite, more preferably has a molar ratio of SiO₂ to Al₂O₃ in the range of from 10:1 to 500:1, more preferably of from 10:1 to 100:1, more preferably of from 10:1 to 40:1, more preferably of from 15:1 to 30:1, more preferably of from 20:1 to 25:1.

Further in the case wherein one or more of the first, second and third washcoat layers comprises a hydrocarbon trap material, it is preferred that independently from one another the molecular sieve, preferably the zeolite, comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.

According to a first alternative, it is preferred that the catalyst displays a layered arrangement of the first and second washcoat layers, wherein the first washcoat layer is provided on the substrate, and wherein the second washcoat layer is provided on the first washcoat layer.

In the case where the catalyst displays a layered arrangement of the first and second washcoat layers, wherein the first washcoat layer is provided on the substrate, and wherein the second washcoat layer is provided on the first washcoat layer, in accordance with the first alternative, it is preferred that the one or more platinum group metals are at least in part contained in the second washcoat layer, wherein preferably the one or more platinum group metals are entirely contained in the second washcoat layer.

Further in the case where the catalyst displays a layered arrangement of the first and second washcoat layers, wherein the first washcoat layer is provided on the substrate, and wherein the second washcoat layer is provided on the first washcoat layer, in accordance with the first alternative, it is preferred that the one or more platinum group metals are at least in part contained in the first washcoat layer, wherein preferably the one or more platinum group metals are entirely contained in the first washcoat layer.

According to a second alternative, it is preferred that the catalyst comprises a third washcoat layer, wherein the catalyst displays a layered arrangement of the first, second, and third washcoat layers, wherein the first washcoat layer is provided on the substrate, the second washcoat layer is provided on the first washcoat layer, and the third washcoat layer is provided on the second washcoat layer. Further, it is preferred that the one or more platinum group metals are at least in part contained in the third washcoat layer, wherein more preferably the one or more platinum group metals are entirely contained in the third washcoat layer.

According to a third alternative, it is preferred that the catalyst comprises a third washcoat layer, wherein the catalyst displays a layered arrangement of the first, second, and third washcoat layers, wherein the first washcoat layer is provided on the substrate, the third washcoat layer is provided on the first washcoat layer, and the second washcoat layer is provided on the third washcoat layer. Further, it is preferred that the one or more platinum group metals are at least in part contained in the third washcoat layer, wherein more preferably the one or more platinum group metals are entirely contained in the third washcoat layer.

In the case wherein the catalyst comprises a third washcoat layer according to the second alternative as defined hereinabove, it is preferred that the catalyst comprises a fourth washcoat layer, wherein the fourth washcoat layer is provided on the second layer, wherein the catalyst displays a zoned arrangement of the third and fourth washcoat layers, wherein the third washcoat layer is provided on the second washcoat layer along the axial length of the substrate starting from the inlet end of the substrate, and wherein the fourth washcoat layer is provided on the second washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the fourth washcoat layer. Alternatively, it is preferred the catalyst comprises a fourth washcoat layer, wherein the fourth washcoat layer is provided on the second layer, wherein the catalyst displays a zoned arrangement of the third and fourth washcoat layers, wherein the fourth washcoat layer is provided on the second washcoat layer along the axial length of the substrate starting from the inlet end of the substrate, and wherein the third washcoat layer is provided on the second washcoat layer along the axial length of the substrate starting from the outlet end of the substrate, wherein the length of the fourth washcoat layer is less than the axial length of the substrate such as to create an upstream zone comprising the fourth washcoat layer and a downstream zone comprising the third washcoat layer. It is particularly preferred for both alternatives defined above that the third and fourth washcoat layers are adjacent to one another.

In the case where the catalyst comprises a third washcoat layer according to the first, second or third alternative as defined hereinabove, it is preferred that the one or more platinum group metals are at least in part contained in the third washcoat layer and/or in the fourth washcoat layer, wherein more preferably the one or more platinum group metals are entirely contained in the third and fourth washcoat layers.

According to a fourth alternative, it is preferred that the catalyst displays a zoned arrangement of the first and second washcoat layers, wherein the second washcoat layer is provided on the substrate along its axial length starting from the inlet end of the substrate, and wherein the first washcoat layer is provided on the substrate along its axial length starting from the outlet end of the substrate, wherein the length of the first washcoat layer is less than the axial length of the substrate such as to create an upstream zone comprising the second washcoat layer and a downstream zone comprising the first washcoat layer.

In the case where the catalyst displays a zoned arrangement of the first and second washcoat layers in accordance with the fourth alternative, it is preferred that the one or more platinum group metals are at least in part contained in the second washcoat layer, wherein more preferably the one or more platinum group metals are entirely contained in the second washcoat layer.

Further in the case where the catalyst displays a zoned arrangement of the first and second washcoat layers in accordance with the fourth alternative, it is preferred that the one or more platinum group metals are at least in part contained in the first washcoat layer, wherein more preferably the one or more platinum group metals are entirely contained in the first washcoat layer.

Further in the case where the catalyst displays a zoned arrangement of the first and second washcoat layers in accordance with the fourth alternative, it is preferred that the first and second washcoat layers are adjacent to one another.

Further in the case where the catalyst displays a zoned arrangement of the first and second washcoat layers in accordance with the fourth alternative, it is preferred that a portion of the second washcoat layer overlaps at least a portion of the first washcoat layer, wherein more preferably the second washcoat layer overlaps the first washcoat layer over a portion ranging from 10 to 100% of the axial length of the first washcoat layer, more preferably from 15 to 80%, and more preferably from 20 to 50%.

According to a fifth alternative, it is preferred that the catalyst comprises a third washcoat layer, wherein the catalyst displays a zoned arrangement of the first, second, and third washcoat layers, wherein the third washcoat layer is provided on the substrate along its axial length starting from the inlet end of the substrate and wherein the first washcoat layer is provided on the substrate along its axial length starting from the outlet end of the substrate, and wherein the second washcoat layer is provided on and entirely covers the first washcoat layer, wherein the length of the first washcoat layer is less than the axial length of the substrate such as to create an upstream zone comprising the third washcoat layer and a downstream zone comprising the first and second washcoat layers, and wherein the one or more platinum group metals are at least in part contained in the third washcoat layer.

According to a sixth alternative, it is preferred that the catalyst comprises a third washcoat layer, wherein the catalyst displays a zoned arrangement of the first, second, and third washcoat layers, wherein the third washcoat layer is provided on the substrate along its axial length starting from the outlet end of the substrate and wherein the first washcoat layer is provided on the substrate along its axial length starting from the inlet end of the substrate, and wherein the second washcoat layer is provided on and entirely covers the first washcoat layer, wherein the length of the first washcoat layer is less than the axial length of the substrate such as to create a downstream zone comprising the third washcoat layer and an upstream zone comprising the first and second washcoat layers, and wherein the one or more platinum group metals are at least in part contained in the third washcoat layer.

In the case where the catalyst comprises a third washcoat layer, wherein the catalyst displays a zoned arrangement of the first, second, and third washcoat layers according to the fifth or sixth alternative, it is preferred that the first and third washcoat layers are adjacent to one another.

Further in the case where the catalyst comprises a third washcoat layer, wherein the catalyst displays a zoned arrangement of the first, second, and third washcoat layers according to the fifth or sixth alternative, it is preferred that the second and third washcoat layers are adjacent to one another. Alternatively, it is preferred that a portion of the second washcoat layer overlaps at least a portion of the third washcoat layer, wherein more preferably the second washcoat layer overlaps the third washcoat layer over a portion ranging from 10 to 100% of the axial length of the third washcoat layer, more preferably from 15 to 80%, and more preferably from 20 to 50%.

Further alternatively, it is preferred that a portion of the third washcoat layer overlaps at least a portion of the second washcoat layer, wherein more preferably the third washcoat layer overlaps the second washcoat layer over a portion ranging from 10 to 100% of the axial length of the second washcoat layer, more preferably from 15 to 80%, and more preferably from 20 to 50%.

Further alternatively, it is preferred that a portion of the first washcoat layer overlaps at least a portion of the third washcoat layer, wherein more preferably the first washcoat layer overlaps the third washcoat layer over a portion ranging from 10 to 100% of the axial length of the third washcoat layer, more preferably from 15 to 80%, and more preferably from 20 to 50%.

In the case wherein a portion of the third washcoat layer overlaps at least a portion of the second washcoat layer, wherein preferably the third washcoat layer overlaps the second washcoat layer over a portion ranging from 10 to 100% of the axial length of the second washcoat layer, more preferably from 15 to 80%, and more preferably from 20 to 50%, it is preferred that the catalyst comprises a fourth washcoat layer, wherein the fourth washcoat layer is provided on the second layer, wherein the catalyst displays a zoned arrangement of the third and fourth washcoat layers, wherein the third washcoat layer is at least partially provided on the substrate along the axial length of the substrate starting from the inlet end of the substrate, and wherein the fourth washcoat layer is provided on the second washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the fourth washcoat layer. Alternatively, it is preferred that the catalyst comprises a fourth washcoat layer, wherein the fourth washcoat layer is provided on the second layer, wherein the catalyst displays a zoned arrangement of the third and fourth washcoat layers, wherein the third washcoat layer is at least partially provided on the substrate along the axial length of the substrate starting from the outlet end of the substrate, and wherein the fourth washcoat layer is provided on the second washcoat layer along the axial length of the substrate starting from the inlet end of the substrate, wherein the length of the fourth washcoat layer is less than the axial length of the substrate such as to create an upstream zone comprising the fourth washcoat layer and a downstream zone comprising the third washcoat layer. It is particularly preferred that the third and fourth washcoat layers are adjacent to one another.

According to a seventh alternative, it is preferred that the catalyst comprises a third washcoat layer, wherein the catalyst displays a zoned arrangement of the first, second, and third washcoat layers, wherein the third washcoat layer is provided on the substrate along its axial length starting from the inlet end of the substrate and wherein the first washcoat layer is provided on the substrate along its axial length starting from the outlet end of the substrate, and wherein the second washcoat layer is provided on and entirely covers the first washcoat layer, wherein the length of the third washcoat layer is less than the axial length of the substrate such as to create an upstream zone comprising the third washcoat layer and a downstream zone comprising the first and second washcoat layers, and wherein the one or more platinum group metals are at least in part contained in the third washcoat layer.

According to an eighth alternative, it is preferred that the catalyst comprises a third washcoat layer, wherein the catalyst displays a zoned arrangement of the first, second, and third washcoat layers, wherein the third washcoat layer is provided on the substrate along its axial length starting from the outlet end of the substrate and wherein the first washcoat layer is provided on the substrate along its axial length starting from the inlet end of the substrate, and wherein the second washcoat layer is provided on and entirely covers the first washcoat layer, wherein the length of the third washcoat layer is less than the axial length of the substrate such as to create a downstream zone comprising the third washcoat layer and an upstream zone comprising the first and second washcoat layers, and wherein the one or more platinum group metals are at least in part contained in the third washcoat layer.

In the case where the catalyst comprises a third washcoat layer, wherein the catalyst displays a zoned arrangement of the first, second, and third washcoat layers according to the seventh or eighth alternative, it is preferred that the first and third washcoat layers are adjacent to one another.

Further in the case where the catalyst comprises a third washcoat layer, wherein the catalyst displays a zoned arrangement of the first, second, and third washcoat layers according to the seventh or eighth alternative, it is preferred that the second and third washcoat layers are adjacent to one another, Alternatively, it is preferred that a portion of the first washcoat layer overlaps at least a portion of the third washcoat layer, wherein more preferably the first washcoat layer overlaps the third washcoat layer over a portion ranging from 10 to 100% of the axial length of the third washcoat layer, more preferably from 15 to 80%, and more preferably from 20 to 50%. Further alternatively, it is preferred that a portion of the second washcoat layer overlaps at least a portion of the third washcoat layer, wherein more preferably the second washcoat layer overlaps the third washcoat layer over a portion ranging from 10 to 100% of the axial length of the third washcoat layer, more preferably from 15 to 80%, and more preferably from 20 to 50%. Further alternatively, it is preferred that a portion of the third washcoat layer overlaps at least a portion of the second washcoat layer, wherein more preferably the third washcoat layer overlaps the second washcoat layer over a portion ranging from 10 to 100% of the axial length of the second washcoat layer, more preferably from 15 to 80%, and more preferably from 20 to 50%.

In the case wherein the catalyst comprises a third washcoat layer according to a seventh alternative, it is preferred that the catalyst comprises a fourth washcoat layer, wherein the catalyst displays a zoned arrangement of the third and fourth washcoat layers, wherein the third washcoat layer is at least partially provided on the substrate along the axial length of the substrate starting from the inlet end of the substrate, and wherein the fourth washcoat layer is provided on the second washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the fourth washcoat layer. Alternatively, it is preferred that the catalyst comprises a fourth washcoat layer, wherein the catalyst displays a zoned arrangement of the third and fourth washcoat layers, wherein the third washcoat layer is at least partially provided on the substrate along the axial length of the substrate starting from the outlet end of the substrate, and wherein the fourth washcoat layer is provided on the second washcoat layer along the axial length of the substrate starting from the inlet end of the substrate, wherein the length of the fourth washcoat layer is less than the axial length of the substrate such as to create an upstream zone comprising the fourth washcoat layer and a downstream zone comprising the third washcoat layer. It is particularly preferred that the third and fourth washcoat layers are adjacent to one another.

Further in the case where the catalyst displays a zoned arrangement of the first and second washcoat layers according to the fourth, fifth, sixth, seventh or eighth alternative, it is preferred that the length of the first washcoat layer ranges from 5 to 100% of the axial length of the substrate, preferably from 10 to 90% of the axial length of the substrate, more preferably from 30 to 80%, more preferably from 45 to 75%, and more preferably from 50 to 70%.

Further in the case where the catalyst displays a zoned arrangement of the first and second washcoat layers according to the fourth, fifth, sixth, seventh or eighth alternative, it is preferred that the length of the second washcoat layer ranges from 5 to 100% of the axial length of the substrate, preferably from 10 to 90% of the axial length of the substrate, more preferably from 30 to 80%, more preferably from 45 to 75%, and more preferably from 50 to 70%.

Further in the case where the catalyst displays a zoned arrangement of the first and second washcoat layers according to the fourth, fifth, sixth, seventh or eighth alternative, it is preferred that the length of the third washcoat layer ranges from 10 to 90% of the axial length of the substrate, more preferably from 30 to 80%, more preferably from 45 to 75%, and more preferably from 50 to 70%. Alternatively, it is preferred that the length of the third washcoat layer ranges from 10 to 90% of the axial length of the substrate, more preferably from 20 to 60%, and more preferably from 35 to 45%.

In the case wherein the catalyst comprises a fourth washcoat layer, it is preferred that the length of the fourth washcoat layer ranges from 10 to 90% of the axial length of the substrate, more preferably from 30 to 70%, more preferably from 45 to 55%, and more preferably from 49 to 51%.

Further in the case wherein the catalyst comprises a fourth washcoat layer, it is preferred that the fourth washcoat layer is substantially free of a sulfur-trap material, wherein more preferably the fourth washcoat layer is free of a sulfur-trap material.

Further in the case wherein the catalyst comprises a fourth washcoat layer, it is preferred that the fourth washcoat layer comprises a hydrocarbon trap material, wherein the hydrocarbon trap material comprises a molecular sieve, more preferably a zeolite, more preferably a zeolite having a maximum pore size of 12-membered rings, more preferably zeolite beta, wherein the molecular sieve, more preferably the zeolite, more preferably comprises SiO₂ and Al₂O₃, wherein the molecular sieve, preferably the zeolite, more preferably has a molar ratio of SiO₂ to Al₂O₃ in the range of from 10:1 to 500:1, more preferably of from 10:1 to 100:1, more preferably of from 10:1 to 40:1, more preferably of from 15:1 to 30:1, more preferably of from 20:1 to 25:1, wherein the molecular sieve, more preferably the zeolite, more preferably comprises Fe, wherein the molecular sieve, more preferably the zeolite, more preferably comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.

In the case wherein the fourth washcoat layer comprises a hydrocarbon trap material, it is preferred that the loading of the hydrocarbon trap material in the fourth washcoat layer is in the range of from 0.01 to 2.0 g/in³, preferably in the range of from 0.05 to 1.0 g/in³, more preferably in the range of from 0.05 to 0.3 g/in³.

Further in the case wherein the catalyst comprises a fourth washcoat layer, it is preferred that the one or more platinum group metals are at least in part contained in the fourth washcoat layer. In the case wherein the one or more platinum group metals are at least in part contained in the fourth washcoat layer, it is preferred that the one or more platinum group metals are supported on a particulate support material, wherein the particulate support material is more preferably selected from the group consisting of Al₂O₃, SiO₂, TiO₂, SiO₂-doped Al₂O₃, Mn oxide-doped Al₂O₃, and mixtures of two or more thereof, wherein preferably the one or more platinum group metals are supported on Al₂O₃ and/or SiO₂-doped Al₂O₃ and/or Mn oxide-doped Al₂O₃, more preferably SiO₂-doped Al₂O₃ or Al₂O₃ or Mn oxide-doped Al₂O₃, wherein the Mn oxide-doped Al₂O₃ preferably comprises from 1 to 10 weight-%, more preferably from 4 to 6 weight-%, of Mn oxide, calculated as MnO₂, based on 100 weight-% of the Mn oxide-doped Al₂O₃.

In the case where the catalyst comprises a third washcoat layer, wherein the catalyst displays a zoned arrangement of the first, second, and third washcoat layers according to the fifth, sixth, seventh or eighth alternative, and wherein the catalyst further comprises a fourth washcoat layer, it is preferred that the one or more platinum group metals are entirely contained in the third and fourth washcoat layers, wherein the weight ratio of the one or more platinum group metals comprised in the third washcoat layer to the one or more platinum group metals comprised in the fourth washcoat layer is in the range of from 0.5:1 to 5.0:1, more preferably 1.0:1 to 2.0:1, more preferably in the range of from 1.4:1 to 1.6:1, wherein the one or more platinum group metals comprised in the third washcoat layer more preferably comprise, more preferably consist of, Pt and Pd, wherein the one or more platinum group metals comprised in the fourth washcoat layer more preferably comprise, more preferably consist of, Pt and Pd.

Further in the case wherein the catalyst comprises a fourth washcoat layer, it is preferred that the one or more platinum group metals are entirely contained in the third washcoat layer and/or in the optional fourth washcoat layer.

It is preferred that the substrate is a metallic substrate or a ceramic substrate, wherein more preferably the substrate is a ceramic substrate, wherein more preferably the substrate comprises cordierite and/or SiC, more preferably cordierite, wherein more preferably, the substrate consists of cordierite and/or SiC, more preferably of cordierite.

In the case where the catalyst displays a zoned arrangement of the first and second washcoat layers according to the fourth, fifth, sixth, seventh or eighth alternative, it is preferred that the substrate consists of two separate monoliths, wherein the first monolith is provided upstream of the second monolith, wherein the washcoat layer or washcoat layers of the upstream zone are contained on the first monolith, and the washcoat layer or washcoat layers of the downstream zone are contained on the second monolith, wherein preferably the first monolith containing the washcoat layer or washcoat layers of the upstream zone and the second monolith containing the washcoat layer or washcoat layers of the downstream zone are obtained or obtainable by sectioning of a catalyst according to any one of the fourth, fifth, sixth, seventh and eighth alternative into two separate monoliths, wherein the washcoat layer or washcoat layers of the upstream zone are contained on the first monolith, and the washcoat layer or washcoat layers of the downstream zone are contained on the second monolith.

It is preferred that the exhaust gas stream contains hydrocarbons, preferably C1 to C20 hydrocarbons, more preferably 02 to C10 hydrocarbons.

Further, the present invention relates to an exhaust gas treatment system comprising an internal combustion engine and an exhaust gas conduit for exhaust gas from the internal combustion engine, wherein the exhaust gas conduit comprises one or more catalysts according to any one of the embodiments disclosed herein, preferably one, two, three or four catalysts according to any one of the embodiments disclosed herein.

It is preferred that the internal combustion engine is a compression ignition engine, more preferably a diesel engine.

It is preferred that the internal combustion engine is a lean gasoline engine.

It is preferred that the internal combustion engine is powered by an oxygenated fuel, wherein the oxygenated fuel preferably comprises one or more of methanol and biofuel.

It is preferred that the system comprises one or more of an electric heater, a fuel burner, a fuel injector, a selective catalytic reduction (SCR) catalyst, an ammonia oxidation (AMOX) catalyst, a catalyzed soot filter (CSF), a diesel particulate filter (DPF), a selective catalytic reduction catalyst on filter (SCRoF), and a diesel exotherm catalyst (DEC).

According to a first alternative, it is preferred that the system comprises in consecutive order in the direction of the exhaust gas: optionally an electric heater or a fuel burner and/or a fuel injector, a catalyst according to any of the embodiments disclosed herein, a catalyst according to any of the embodiments disclosed herein, a selective catalytic reduction (SCR) catalyst, a selective catalytic reduction (SCR) catalyst, an optional fuel injector, a diesel exotherm catalyst (DEC), a catalyzed soot filter (CSF), a selective catalytic reduction (SCR) catalyst, and a selective catalytic reduction (SCR) catalyst.

According to a second alternative, it is preferred that the system comprises in consecutive order in the direction of the exhaust gas: optionally an electric heater or a fuel burner and/or a fuel injector, a catalyst according to any of the embodiments disclosed herein, a catalyst according to any of the embodiments disclosed herein, a selective catalytic reduction (SCR) catalyst, a selective catalytic reduction (SCR) catalyst, an optional fuel injector, a diesel exotherm catalyst (DEC), a diesel particulate filter (DPF), a selective catalytic reduction (SCR) catalyst, and a selective catalytic reduction (SCR) catalyst.

According to a third alternative, it is preferred that the system comprises in consecutive order in the direction of the exhaust gas: optionally an electric heater or a fuel burner and/or a fuel injector, a catalyst according to any of the embodiments disclosed herein, a catalyst according to any of the embodiments disclosed herein, a selective catalytic reduction (SCR) catalyst, a selective catalytic reduction (SCR) catalyst, an optional fuel injector, a diesel exotherm catalyst (DEC), a diesel particulate filter (DPF), a selective catalytic reduction (SCR) catalyst, and an ammonia oxidation (AMOX) catalyst.

According to a fourth alternative, it is preferred that the system comprises in consecutive order in the direction of the exhaust gas: optionally an electric heater or a fuel burner and/or a fuel injector, a catalyst according to any of the embodiments disclosed herein, a catalyst according to any of the embodiments disclosed herein, a selective catalytic reduction (SCR) catalyst, a selective catalytic reduction (SCR) catalyst, an optional fuel injector, a catalyst according to any of the embodiments disclosed herein, a diesel particulate filter (DPF), a selective catalytic reduction (SCR) catalyst, and a selective catalytic reduction (SCR) catalyst.

According to a fifth alternative, it is preferred that the system comprises in consecutive order in the direction of the exhaust gas: optionally an electric heater or a fuel burner and/or a fuel injector, a catalyst according to any of the embodiments disclosed herein, a catalyst according to any of the embodiments disclosed herein, a selective catalytic reduction (SCR) catalyst, a selective catalytic reduction (SCR) catalyst, an optional fuel injector, a catalyst according to any of the embodiments disclosed herein, a catalyst according to any of the embodiments disclosed herein, wherein the substrate is a wall-flow substrate, a selective catalytic reduction (SCR) catalyst, and an ammonia oxidation (AMOX) catalyst.

According to a sixth alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction (SCR) catalyst, a selective catalytic reduction (SCR) catalyst, a catalyzed soot filter (CSF), a selective catalytic reduction (SCR) catalyst, and a selective catalytic reduction (SCR) catalyst.

According to a seventh alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction (SCR) catalyst, a selective catalytic reduction (SCR) catalyst, a catalyzed soot filter (CSF), a selective catalytic reduction (SCR) catalyst, and an ammonia oxidation (AMOX) catalyst.

According to an eighth alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction (SCR) catalyst, a selective catalytic reduction (SCR) catalyst, an optional fuel injector, a catalyst according to any of the embodiments disclosed herein, wherein the substrate is a wall-flow substrate, a selective catalytic reduction (SCR) catalyst, and an ammonia oxidation (AMOX) catalyst.

According to an ninth alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction (SCR) catalyst, a selective catalytic reduction catalyst on filter (SCRoF), and an ammonia oxidation (AMOX) catalyst.

According to an tenth alternative, it is preferred that the system comprises in consecutive order in the direction of the exhaust gas: optionally an electric heater or a fuel burner and/or a fuel injector, a selective catalytic reduction (SCR) catalyst, an optional fuel injector, a catalyst according to any of the embodiments disclosed herein, a selective catalytic reduction catalyst on filter (SCRoF), and an ammonia oxidation (AMOX) catalyst.

According to an eleventh alternative, it is preferred that the system comprises in consecutive order in the direction of the exhaust gas: optionally an electric heater or a fuel burner and/or a fuel injector, a selective catalytic reduction (SCR) catalyst, an optional fuel injector, a catalyst according to any of the embodiments disclosed herein, a catalyzed soot filter (CSF), a selective catalytic reduction (SCR) catalyst, and an ammonia oxidation (AMOX) catalyst.

According to an twelfth alternative, it is preferred that the system comprises in consecutive order in the direction of the exhaust gas: optionally an electric heater or a fuel burner and/or a fuel injector, a selective catalytic reduction (SCR) catalyst, an optional fuel injector, a catalyst according to any of the embodiments disclosed herein, a catalyst according to any of the embodiments disclosed herein, wherein the substrate is a wall-flow substrate, a selective catalytic reduction (SCR) catalyst, and an ammonia oxidation (AMOX) catalyst.

According to a thirteenth alternative, it is preferred that the system comprises in consecutive order in the direction of the exhaust gas: optionally an electric heater or a fuel burner and/or a fuel injector, a catalyst according to any of the embodiments disclosed herein, a diesel particulate filter (DPF), a selective catalytic reduction (SCR) catalyst, a selective catalytic reduction (SCR) catalyst, a selective catalytic reduction (SCR) catalyst, a selective catalytic reduction (SCR) catalyst, and an ammonia oxidation (AMOX) catalyst.

According to a fourteenth alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction catalyst on filter (SCRoF), a selective catalytic reduction (SCR) catalyst, and an ammonia oxidation (AMOX) catalyst.

According to a fifteenth alternative, it is preferred that the system comprises in consecutive order in the direction of the exhaust gas: optionally an electric heater or a fuel burner and/or a fuel injector, a catalyst according to any of the embodiments disclosed herein, a selective catalytic reduction (SCR) catalyst, a selective catalytic reduction catalyst on filter (SCRoF), a selective catalytic reduction (SCR) catalyst, and an ammonia oxidation (AMOX) catalyst.

Yet further, the present invention relates to a method for the treatment of an exhaust gas stream containing one or more of formaldehyde, nitrogen oxide (NO), and hydrocarbons, the method comprising
(A) providing an exhaust gas stream comprising one or more of formaldehyde, nitrogen oxide (NO), and hydrocarbons;
(B) directing the exhaust gas stream provided in (A) through a catalyst according to any one of the embodiments disclosed herein.

It is preferred that the exhaust gas stream provided in (A) comprises one or more sulfur-containing compounds, more preferably SO₂ and/or SO₃.

It is preferred that the exhaust gas stream provided in (A) comprises NOₓ.

It is preferred that the exhaust gas stream provided in (A) comprises CO.

It is preferred that the exhaust gas stream provided in (A) comprises formaldehyde.

It is preferred that the exhaust gas stream provided in (A) comprises nitrogen oxide (NO).

It is preferred that the exhaust gas stream provided in (A) comprises hydrocarbons, preferably C1 to C20 hydrocarbons, more preferably 02 to 010 hydrocarbons.

Yet further, the present invention relates to a use of a catalyst according to any one of the embodiments disclosed herein for the oxidation of one or more of formaldehyde, nitrogen oxide (NO), and hydrocarbons, more preferably for the oxidation of one or more of formaldehyde, nitrogen oxide (NO), and hydrocarbons in an exhaust gas stream, more preferably for the oxidation of one or more of formaldehyde, nitrogen oxide (NO), and hydrocarbons in the exhaust gas stream of an internal combustion engine, more preferably for the oxidation of one or more of formaldehyde, nitrogen oxide (NO), and hydrocarbons in the exhaust gas stream of a compression ignition engine, more preferably for the oxidation of one or more of formaldehyde, nitrogen oxide (NO), and hydrocarbons in the exhaust gas stream of a diesel engine.

The present invention is further illustrated by the following set of embodiments and combinations of embodiments resulting from the dependencies and back-references as indicated. In particular, it is noted that in each instance where a range of embodiments is mentioned, for example in the context of a term such as “The catalyst of any one of embodiments 1 to 4”, every embodiment in this range is meant to be explicitly disclosed for the skilled person, i.e. the wording of this term is to be understood by the skilled person as being synonymous to “The catalyst of any one of embodiments 1, 2, 3, and 4”. Further, it is explicitly noted that the following set of embodiments represents a suitably structured part of the general description directed to preferred aspects of the present invention, and, thus, suitably supports, but does not represent the claims of the present invention.
1. A catalyst for the treatment of an exhaust gas stream containing one or more of formaldehyde, nitrogen oxide (NO), and hydrocarbons, the catalyst comprising
   a first washcoat layer comprising Mn,
   a second washcoat layer comprising a sulfur-trap material which may be desulfated, and
   a substrate,
   wherein the substrate preferably has an inlet end through which the exhaust gas stream may enter the catalyst, and an outlet end through which the exhaust gas stream may exit the catalyst, wherein the exhaust gas stream flowing through the catalyst preferably first comes into contact with the second washcoat layer prior to coming into contact with the first washcoat layer,
   wherein the catalyst further comprises one or more platinum group metals comprising Pt, Pd, or Pt and Pd, wherein the one or more platinum group metals are at least in part contained in one or more of:
   (a) the first washcoat layer,
   (b) the second washcoat layer, and
   (c) an optional third washcoat layer, or
   (d) optional third and fourth washcoat layers.
2. The catalyst of embodiment 1, wherein the second washcoat layer is substantially free of Mn, wherein preferably the second washcoat layer is free of Mn.
3. The catalyst of embodiment 1 or 2, wherein the first washcoat layer is substantially free of a sulfur-trap material, wherein preferably the first washcoat layer is free of a sulfur-trap material.
4. The catalyst of any of embodiments 1 to 3, wherein the first washcoat layer is substantially free of the one or more platinum group metals, wherein preferably the first washcoat layer is free of the one or more platinum group metals.
5. The catalyst of any of embodiments 1 to 4, wherein the loading of Mn, calculated as the element, in the first washcoat layer is in the range of from 1 to 50 wt.-% based on 100 wt. % of the first washcoat layer, preferably from 2 to 30 wt.-%, more preferably from 5 to 20 wt.-%, more preferably from 8 to 12 wt.-%.
6. The catalyst of any of embodiments 1 to 5, wherein Mn is present in the form of one or more cations of Mn, wherein Mn is preferably contained in the first washcoat layer as one or more oxides, wherein Mn is more preferably contained in the first washcoat layer as one or more oxides of Mn(II), Mn(III), Mn(II/III), and Mn(IV), more preferably as one or more oxides selected from the group consisting of MnO, Mn₂O₃, Mn₃O₄, MnO₂, Mn(O)OH, and Mn-Zr mixed oxides, including mixtures of two or more thereof, wherein the Mn-Zr mixed oxides are preferably contained in the first washcoat layer as a solid solution.
7. The catalyst of any of embodiments 1 to 6, wherein the first washcoat layer comprises a particulate support material, wherein Mn is supported on the particulate support material, wherein the particulate support material is preferably selected from the group consisting of ZrO₂, Al₂O₃, SiO₂, TiO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, praseodymium oxide-doped CeO₂—ZrO₂ mixed oxide, ZrO₂-doped Al₂O₃, ZrO₂-doped SiO₂, SiO₂-doped Al₂O₃, CuO—Al₂O₃ mixed oxide, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, PrO₂-doped CeO₂—ZrO₂ mixed oxide, ZrO₂-doped Al₂O₃, ZrO₂-doped SiO₂, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, and mixtures of two or more thereof, wherein more preferably Mn is supported on particulate La₂O₃-doped ZrO₂.
8. The catalyst of any of embodiments 1 to 7, wherein the first washcoat layer comprises Ce, wherein Ce is preferably contained in the first washcoat layer as CeO₂ and/or Ce₂O₃.
9. The catalyst of embodiment 8, wherein the loading of Ce, calculated as the element, in the first washcoat layer is in the range of from 1 to 50 wt.-% based on 100 wt.-% of the first washcoat layer, preferably from 2 to 30 wt.-%, more preferably from 5 to 20 wt.-%, more preferably from 8 to 12 wt.-%.
10. The catalyst of embodiment 8 or 9, wherein Ce is supported on a particulate support material, wherein the particulate support material is preferably selected from the group consisting of ZrO₂, Al₂O₃, SiO₂, TiO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, praseodymium oxide-doped CeO₂—ZrO₂ mixed oxide, ZrO₂-doped Al₂O₃, ZrO₂-doped SiO₂, SiO₂-doped Al₂O₃, CuO-Al₂O₃ mixed oxide, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, PrO₂-doped CeO₂—ZrO₂ mixed oxide, ZrO₂-doped Al₂O₃, ZrO₂-doped SiO₂, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, and mixtures of two or more thereof, wherein more preferably Ce is supported on particulate La₂O₃-doped ZrO₂.
11. The catalyst of any of embodiments 1 to 10, wherein the first washcoat layer comprises Cu, wherein the first washcoat layer preferably comprises CuO, Cu₂O, or CuO and Cu₂O, more preferably CuO.
12. The catalyst of embodiment 11, wherein the loading of Cu, calculated as the element, in the first washcoat layer is in the range of from 1 to 50 wt.-% based on 100 wt.-% of the first washcoat layer, preferably from 2 to 30 wt.-%, more preferably from 5 to 20 wt.-%, more preferably from 8 to 12 wt.-%.
13. The catalyst of embodiment 11 or 12, wherein Cu is supported on a particulate support material, wherein the particulate support material is preferably selected from the group consisting of ZrO₂, Al₂O₃, SiO₂, TiO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, praseodymium oxide-doped CeO₂—ZrO₂ mixed oxide, ZrO₂-doped Al₂O₃, ZrO₂-doped SiO₂, SiO₂-doped Al₂O₃, CuO-Al₂O₃ mixed oxide, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, PrO₂-doped CeO₂—ZrO₂ mixed oxide, ZrO₂-doped Al₂O₃, ZrO₂-doped SiO₂, and mixtures of two or more thereof, more preferably from the group consisting of ZrO₂, La₂O₃-doped ZrO₂, CeO₂—ZrO₂ mixed oxide, La₂O₃-doped CeO₂—ZrO₂ mixed oxide, Nd₂O₃-doped CeO₂—ZrO₂ mixed oxide, Y₂O₃-doped CeO₂—ZrO₂ mixed oxide, Pr₂O₃-doped CeO₂—ZrO₂ mixed oxide, Pr₆O₁₁-doped CeO₂—ZrO₂ mixed oxide, and mixtures of two or more thereof, wherein more preferably Cu is supported on particulate La₂O₃-doped ZrO₂.
14. The catalyst of any of embodiments 1 to 13, wherein the loading of the sulfur-trap material in the second washcoat layer is in the range of from 5 to 100 wt.-% based on 100 wt.-% of the second washcoat layer, preferably from 10 to 95 wt.-%, more preferably from 20 to 90 wt.-%, more preferably from 30 to 80 wt.-%, more preferably from 40 to 70 wt.-%.
15. The catalyst of any of embodiments 1 to 14, wherein the sulfur-trap material comprises one or more metal oxides which react with SO₂ and/or SO₃ to form corresponding metal sulfites and/or sulfates, wherein preferably the sulfur-trap material consists of the one or more metal oxides.
16. The catalyst of embodiment 15, wherein each of the one or more metal oxides, which react with SO₂ and/or SO₃ to form corresponding metal sulfite and/or sulfate, displays a desulfation temperature T₅₀, at which 50% of the respective metal sulfite and/or metal sulfate has decomposed to the metal oxide and SO₂ and/or SO₃, which is lower than the desulfation temperature T₅₀ of MnSO₄, wherein preferably, each of the one or more metal oxides displays a desulfation temperature T₅₀ which is at least 10° C. lower than the desulfation temperature T₅₀ of MnSO₄, preferably at least 20° C. lower, more preferably at least 50° C. lower, more preferably at least 80° C. lower, more preferably at least 100° C. lower, more preferably at least 150° C. lower.
17. The catalyst of embodiment 15 or 16, wherein the one or more metal oxides are selected from the group consisting of oxides of Cu, Ni, Co, Fe, Ce, La, Sn, and Zr, including mixtures of two or more thereof, preferably from the group consisting of oxides of Cu, Fe, Ce, La, Sn, and Zr, including mixtures of two or more thereof, more preferably from the group consisting of oxides of Cu, Fe, Sn, La, and Zr, including mixtures of two or more thereof, more preferably from the group consisting of oxides of Cu, Fe, La, and Zr, including mixtures of two or more thereof, wherein more preferably the one or more metal oxides comprise, preferably consist of, oxides of Zr, La, and/or Fe; and/or wherein the one or more metal oxides are preferably selected from the group consisting of oxides of Fe, Cu, and Sn, including mixtures of two or more thereof, more preferably from the list consisting of Fe₂O₃, CuO, and SnO₂, including mixtures of two or more thereof.
18. The catalyst of any of embodiment 15 to 17, wherein the one or more metal oxides comprise, preferably consist of, oxides of Fe, wherein preferably the one or more metal oxides comprise, preferably consist of, Fe₂O₃ and/or Fe₂O₃-doped Al₂O₃; and/or wherein the one or more metal oxides comprise oxides of Fe, wherein the loading of the one or more oxides of Fe in the second washcoat layer is in the range of from 10 to 70 wt.-%, calculated as Fe₂O₃ and based on 100 wt.-% of the second washcoat layer.
19. The catalyst of embodiment 18, wherein the loading of the one or more oxides of Fe in the second washcoat layer is in the range of from 1 to 100 wt.-%, calculated as Fe₂O₃ and based on 100 wt.-% of the second washcoat layer, preferably from 5 to 80 wt.-%, more preferably from 10 to 70 wt.-%, more preferably from 15 to 65 wt.-%, more preferably from 20 to 60 wt.-%, more preferably from 30 to 50 wt.-%, more preferably from 35 to 45 wt.-%.
20. The catalyst of embodiment 18 or 19, wherein the one or more oxides of Fe display an average particle size D50 of 20 μm or less, preferably of 10 μm or less, more preferably of 5 μm or less, more preferably of 1 μm or less, wherein the average particle size is preferably determined according to ISO 13320:2020. 21. The catalyst of any of embodiment 18 to 20, wherein the second washcoat layer comprises one or more oxides selected from the group consisting of Al₂O₃, SiO₂, SiO₂-doped Al₂O₃, and mixtures of two or more thereof, wherein preferably the second washcoat layer comprises Al₂O₃ and/or SiO₂-doped Al₂O₃, more preferably Al₂O₃.
22. The catalyst of embodiment 21, wherein the loading of the one or more oxides in the second washcoat layer is in the range of from 0 to 99 wt.-% based on 100 wt.-% of the second washcoat layer, preferably from 20 to 95 wt.-%, more preferably from 30 to 90 wt.-%, more preferably from 40 to 80 wt.-%, more preferably from 45 to 75 wt.-%, more preferably from 50 to 70 wt.-%, more preferably from 55 to 65 wt.-%.
23. The catalyst of any of embodiments 15 to 22, wherein the one or more metal oxides comprise, preferably consist of, ZrO₂.
24. The catalyst of embodiment 23, wherein the loading of ZrO₂ in the second washcoat layer is in the range of from 35 to 100 wt.-% based on 100 wt.-% of the second washcoat layer, preferably from 45 to 100 wt.-%, more preferably from 75 to 95 wt.-%, more preferably from 85 to 90 wt.-%.
25. The catalyst of embodiment 23 or 24, wherein ZrO₂ is doped with La₂O₃, wherein ZrO₂ and La₂O₃ preferably form a solid solution.
26. The catalyst of embodiment 25, wherein preferably ZrO₂ is doped with La₂O₃ in an amount ranging from 1 to 50 wt. % based on 100 wt.-% of ZrO₂ and La₂O₃, preferably from 3 to 30 wt.-%, more preferably from 5 to 15 wt.-%, more preferably from 8 to 10 wt.-%.
27. The catalyst of any of embodiment 15 to 26, wherein the one or more metal oxides comprise CeO₂-ZrO₂ mixed oxide and/or rare earth metal doped CeO₂-ZrO₂ mixed oxide, wherein the rare earth metal doped CeO₂-ZrO₂ mixed oxide preferably comprises CeO₂ in an amount in the range of 10 to 95 wt.-%, more preferably in the range of 20 to 90 wt.-%, based on 100 wt.-% of the rare earth metal doped CeO₂-ZrO₂ mixed oxide, wherein preferably the CeO₂-ZrO₂ mixed oxide comprises ZrO₂ in an amount in the range of 5 to 75 wt.-%, more preferably in the range of 9 to 70 wt.-%, based on 100 wt.-% of the rare earth metal doped CeO₂-ZrO₂ mixed oxide,
   wherein more preferably the rare earth metal doped CeO₂-ZrO₂ mixed oxide further comprises La₂O₃ as dopant, preferably in an amount in the range of 1 to 10 wt.-%, more preferably in an amount in the range of 1 to 5 wt.-%, more preferably in the range of 2 to 4 wt. %, based on 100 wt.-% of the rare earth metal doped CeO₂-ZrO₂ mixed oxide,
   wherein more preferably the rare earth metal doped CeO₂-ZrO₂ mixed oxide further comprises Y₂O₃ as dopant, preferably in an amount in the range of 1 to 10 wt.-%, more preferably in an amount in the range of 1 to 5 wt.-%, more preferably in the range of 2 to 4 wt. %, based on 100 wt.-% of the rare earth metal doped CeO₂-ZrO₂ mixed oxide,
   wherein more preferably the rare earth metal doped CeO₂-ZrO₂ mixed oxide further comprises Nd₂O₃ as dopant, preferably in an amount in the range of 1 to 10 wt.-%, more preferably in an amount in the range of 3 to 7 wt.-%, more preferably in the range of 4 to 6 wt. %, based on 100 wt.-% of the rare earth metal doped CeO₂-ZrO₂ mixed oxide,
   wherein more preferably the rare earth metal doped CeO₂-ZrO₂ mixed oxide further comprises praseodymium oxide, preferably Pr₂O₃ and/or Pr₆O₁₁, as dopant, preferably in an amount in the range of 1 to 10 wt.-%, more preferably in an amount in the range of 3 to 7 wt.-%, more preferably in the range of 4 to 6 wt.-%, based on 100 wt.-% of the rare earth metal doped CeO₂-ZrO₂ mixed oxide.
28. The catalyst of embodiment 27, wherein La₂O₃ is supported on the CeO₂-ZrO₂ mixed oxide and/or rare earth metal doped CeO₂-ZrO₂ mixed oxide, preferably in an amount in the range of 1 to 20 wt.-%, more preferably in an amount in the range of 5 to 15 wt.-%, more preferably in the range of 9 to 11 wt.-%, based on 100 wt.-% of the CeO₂-ZrO₂ mixed oxide and/or rare earth metal doped CeO₂-ZrO₂ mixed oxide.
29. The catalyst of any of embodiments 23 to 28, wherein the one or more metal oxides further comprise one or more metal oxides selected from the list consisting of oxides of Fe, Cu, and Sn, including mixtures of two or more thereof, preferably from the list consisting of Fe₂O₃, CuO, and SnO₂, including mixtures of two or more thereof.
30. The catalyst of any of embodiments 1 to 29, wherein the substrate is a wall-flow substrate or a flow-through substrate, preferably a honeycomb wall-flow substrate or a honeycomb flow-through substrate, more preferably a honeycomb flow-through substrate, wherein the flow-through substrate is more preferably a flow through substrate with high porosity walls.
31. The catalyst of any of embodiments 1 to 30, wherein the loading of the first washcoat layer is in the range of from 0.5 to 8 g/in³, preferably of from 0.8 to 7 g/in³, more preferably of from 0.9 to 6 g/in³, more preferably of from 1 to 5 g/in³, more preferably of from 1.5 to 3 g/in³, more preferably of from 2 to 2.5 g/in³.
32. The catalyst of any of embodiments 1 to 31, wherein the loading of the second washcoat layer is in the range of from 0.1 to 5 g/in³, preferably of from 0.25 to 4 g/in³, more preferably of from 0.3 to 3 g/in³, more preferably of from 0.4 to 2.5 g/in³, more preferably of from 0.5 to 2 g/in³, more preferably of from 0.8 to 1.2 g/in³.
33. The catalyst of any of embodiments 1 to 32, wherein the loading of the third washcoat layer is in the range of from 0.25 to 3.0 g/in³, preferably of from 0.5 to 2.5 g/in³, more preferably of from 1 to 2 g/in³.
34. The catalyst of any of embodiments 1 to 33, wherein the loading of the fourth washcoat layer is in the range of from 0.25 to 3.0 g/in³, preferably of from 0.5 to 2.5 g/in³, more preferably of from 1 to 2 g/in³.
35. The catalyst of any of embodiments 1 to 34, wherein the catalyst comprises one or more platinum group metals consisting of Pt, Pd, or Pt and Pd, wherein preferably the catalyst comprises Pt, or Pt and Pd as the one or more platinum group metals, wherein more preferably the catalyst comprises Pt and Pd as the one or more platinum group metals.
36. The catalyst of any of embodiments 1 to 35, wherein the catalyst comprises Pt, calculated as the element, at a loading in the range of from 2 to 250 g/ft³, preferably of from 5 to 150 g/ft³, more preferably of from 10 to 125 g/ft³, more preferably of from 20 to 100 g/ft³, more preferably of from 25 to 85 g/ft³, more preferably of from 30 to 80 g/ft³, more preferably of from 40 to 60 g/ft³.
37. The catalyst of any of embodiments 1 to 36, wherein the catalyst comprises Pd, calculated as the element, at a loading in the range of from 1 to 80 g/ft³, preferably of from 5 to 60 g/ft³, more preferably of from 10 to 50 g/ft³, more preferably of from 15 to 40 g/ft³, more preferably of from 20 to 30 g/ft³.
38. The catalyst of any of embodiments 1 to 37, wherein the catalyst comprises Pt and Pd, calculated as the respective element, at a total Pt and Pd loading in the range of from 2 to 250 g/ft³, preferably of from 5 to 200 g/ft³, more preferably of from 10 to 150 g/ft³, more preferably of from 20 to 130 g/ft³, more preferably of from 30 to 125 g/ft³, more preferably of from 40 to 110 g/ft³, more preferably of from 50 to 100 g/ft³, more preferably of from 60 to 90 g/ft³, more preferably of from 70 to 80 g/ft³.
39. The catalyst of any of embodiments 1 to 38, wherein the catalyst comprises Pt and Pd at a Pt:Pd weight ratio in the range of from 30:70 to 90:10, preferably of from 50:50 to 80:20, more preferably of from 60:40 to 75:25, more preferably of from 65:35 to 70:30.
40. The catalyst of any of embodiments 1 to 39, wherein the one or more platinum group metals are supported on a particulate support material, wherein the particulate support material is preferably selected from the group consisting of Al₂O₃, SiO₂, TiO₂, SiO₂-doped Al₂O₃, Mn oxide-doped Al₂O₃, and mixtures of two or more thereof, wherein preferably the one or more platinum group metals are supported on Al₂O₃ and/or SiO₂-doped Al₂O₃ and/or Mn oxide-doped Al₂O₃, more preferably SiO₂-doped Al₂O₃ or Al₂O₃ or Mn oxide-doped Al₂O₃, wherein the Mn oxide-doped Al₂O₃ preferably comprises from 1 to 10 weight %, more preferably from 4 to 6 weight-%, of Mn oxide, calculated as MnO₂, based on 100 weight-% of the Mn oxide-doped Al₂O₃.
41. The catalyst of any of embodiments 1 to 40, wherein the catalyst comprises a third washcoat layer, wherein the one or more platinum group metals are at least in part contained in the third washcoat layer, wherein preferably the one or more platinum group metals are entirely contained in the third washcoat layer.
42. The catalyst of any of embodiments 1 to 41, wherein the catalyst comprises a third washcoat layer, wherein the third washcoat layer comprises a hydrocarbon trap material, wherein the hydrocarbon trap material comprises a molecular sieve, preferably a zeolite, more preferably a zeolite having a maximum pore size of 12-membered rings, more preferably zeolite beta, wherein the third washcoat layer preferably comprises the hydrocarbon trap material in an amount in the range of from 0.01 to 2.0 g/in³, preferably in the range of from 0.05 to 1.0 g/in³, more preferably in the range of from 0.05 to 0.3 g/in³.
43. The catalyst of any of embodiments 1 to 42, wherein the first washcoat layer comprises a hydrocarbon trap material, wherein the hydrocarbon trap material comprises a molecular sieve, preferably a zeolite, more preferably a zeolite having a maximum pore size of 12-membered rings, more preferably zeolite beta, wherein the first washcoat layer preferably comprises the hydrocarbon trap material in an amount in the range of from 0.01 to 2.0 g/in³, preferably in the range of from 0.05 to 1.0 g/in³, more preferably in the range of from 0.05 to 0.3 g/in³.
44. The catalyst of any of embodiments 1 to 43, wherein the second washcoat layer comprises a hydrocarbon trap material, wherein the hydrocarbon trap material comprises a molecular sieve, preferably a zeolite, more preferably a zeolite having a maximum pore size of 12-membered rings, more preferably zeolite beta, wherein the second washcoat layer preferably comprises the hydrocarbon trap material in an amount in the range of from 0.01 to 2.0 g/in³, preferably in the range of from 0.05 to 1.0 g/in³, more preferably in the range of from 0.05 to 0.3 g/in³.
45. The catalyst of any one of embodiments 42 to 44, wherein the hydrocarbon trap material comprises a molecular sieve, preferably a zeolite, wherein the molecular sieve, preferably the zeolite, comprises SiO₂ and Al₂O₃, wherein the molecular sieve, preferably the zeolite, more preferably has a molar ratio of SiO₂ to Al₂O₃ in the range of from 10:1 to 500:1, preferably of from 10:1 to 100:1, more preferably of from 10:1 to 40:1, preferably of from 15:1 to 30:1, more preferably of from 20:1 to 25:1.
46. The catalyst of embodiment 45, wherein the molecular sieve, preferably the zeolite, comprises Fe, wherein the molecular sieve, preferably the zeolite, preferably comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.
47. The catalyst of any of embodiments 1 to 46, wherein the catalyst displays a layered arrangement of the first and second washcoat layers, wherein the first washcoat layer is provided on the substrate, and wherein the second washcoat layer is provided on the first washcoat layer.
48. The catalyst of embodiment 47, wherein the one or more platinum group metals are at least in part contained in the second washcoat layer, wherein preferably the one or more platinum group metals are entirely contained in the second washcoat layer.
49. The catalyst of embodiment 47 or 48, wherein the one or more platinum group metals are at least in part contained in the first washcoat layer, wherein preferably the one or more platinum group metals are entirely contained in the first washcoat layer.
50. The catalyst of any of embodiments 1 to 46, wherein the catalyst comprises a third washcoat layer, wherein the catalyst displays a layered arrangement of the first, second, and third washcoat layers, wherein the first washcoat layer is provided on the substrate, the second washcoat layer is provided on the first washcoat layer, and the third washcoat layer is provided on the second washcoat layer.
51. The catalyst of any of embodiments 1 to 46, wherein the catalyst comprises a third washcoat layer, wherein the catalyst displays a layered arrangement of the first, second, and third washcoat layers, wherein the first washcoat layer is provided on the substrate, the third washcoat layer is provided on the first washcoat layer, and the second washcoat layer is provided on the third washcoat layer.
52. The catalyst of embodiment 50, wherein the catalyst comprises a fourth washcoat layer, wherein the fourth washcoat layer is provided on the second layer, wherein the catalyst displays a zoned arrangement of the third and fourth washcoat layers, wherein the third washcoat layer is provided on the second washcoat layer along the axial length of the substrate starting from the inlet end of the substrate, and wherein the fourth washcoat layer is provided on the second washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the fourth washcoat layer.
53. The catalyst of embodiment 50, wherein the catalyst comprises a fourth washcoat layer, wherein the fourth washcoat layer is provided on the second layer, wherein the catalyst displays a zoned arrangement of the third and fourth washcoat layers, wherein the fourth washcoat layer is provided on the second washcoat layer along the axial length of the substrate starting from the inlet end of the substrate, and wherein the third washcoat layer is provided on the second washcoat layer along the axial length of the substrate starting from the outlet end of the substrate, wherein the length of the fourth washcoat layer is less than the axial length of the substrate such as to create an upstream zone comprising the fourth washcoat layer and a downstream zone comprising the third washcoat layer.
54. The catalyst of embodiment 52 or 53, wherein the third and fourth washcoat layers are adjacent to one another.
55. The catalyst of any of embodiments 50 to 54, wherein the one or more platinum group metals are at least in part contained in the third washcoat layer and/or in the fourth washcoat layer, wherein preferably the one or more platinum group metals are entirely contained in the third and fourth washcoat layers.
56. The catalyst of any of embodiments 1 to 46, wherein the catalyst displays a zoned arrangement of the first and second washcoat layers, wherein the second washcoat layer is provided on the substrate along its axial length starting from the inlet end of the substrate, and wherein the first washcoat layer is provided on the substrate along its axial length starting from the outlet end of the substrate, wherein the length of the first washcoat layer is less than the axial length of the substrate such as to create an upstream zone comprising the second washcoat layer and a downstream zone comprising the first washcoat layer.
57. The catalyst of embodiment 56, wherein the one or more platinum group metals are at least in part contained in the second washcoat layer, wherein preferably the one or more platinum group metals are entirely contained in the second washcoat layer.
58. The catalyst of embodiment 56 or 57, wherein the one or more platinum group metals are at least in part contained in the first washcoat layer, wherein preferably the one or more platinum group metals are entirely contained in the first washcoat layer.
59. The catalyst of any of embodiments 56 to 58, wherein the first and second washcoat layers are adjacent to one another.
60. The catalyst of any of embodiments 56 to 58, wherein a portion of the second washcoat layer overlaps at least a portion of the first washcoat layer, wherein preferably the second washcoat layer overlaps the first washcoat layer over a portion ranging from 10 to 100% of the axial length of the first washcoat layer, more preferably from 15 to 80%, and more preferably from 20 to 50%.
61. The catalyst of any of embodiments 1 to 46, wherein the catalyst comprises a third washcoat layer, wherein the catalyst displays a zoned arrangement of the first, second, and third washcoat layers, wherein the third washcoat layer is provided on the substrate along its axial length starting from the inlet end of the substrate and wherein the first washcoat layer is provided on the substrate along its axial length starting from the outlet end of the substrate, and wherein the second washcoat layer is provided on and entirely covers the first washcoat layer, wherein the length of the first washcoat layer is less than the axial length of the substrate such as to create an upstream zone comprising the third washcoat layer and a downstream zone comprising the first and second washcoat layers, and wherein the one or more platinum group metals are at least in part contained in the third washcoat layer.
62. The catalyst of any of embodiments 1 to 46, wherein the catalyst comprises a third washcoat layer, wherein the catalyst displays a zoned arrangement of the first, second, and third washcoat layers, wherein the third washcoat layer is provided on the substrate along its axial length starting from the outlet end of the substrate and wherein the first washcoat layer is provided on the substrate along its axial length starting from the inlet end of the substrate, and wherein the second washcoat layer is provided on and entirely covers the first washcoat layer, wherein the length of the first washcoat layer is less than the axial length of the substrate such as to create a downstream zone comprising the third washcoat layer and an upstream zone comprising the first and second washcoat layers, and wherein the one or more platinum group metals are at least in part contained in the third washcoat layer.
63. The catalyst of embodiment 61 or 62, wherein the first and third washcoat layers are adjacent to one another.
64. The catalyst of any of embodiments 61 to 63, wherein the second and third washcoat layers are adjacent to one another.
65. The catalyst of any of embodiments 61 to 63, wherein a portion of the first washcoat layer overlaps at least a portion of the third washcoat layer, wherein preferably the first washcoat layer overlaps the third washcoat layer over a portion ranging from 10 to 100% of the axial length of the third washcoat layer, more preferably from 15 to 80%, and more preferably from 20 to 50%.
66. The catalyst of any of embodiments 61 to 63, wherein a portion of the second washcoat layer overlaps at least a portion of the third washcoat layer, wherein preferably the second washcoat layer overlaps the third washcoat layer over a portion ranging from 10 to 100% of the axial length of the third washcoat layer, more preferably from 15 to 80%, and more preferably from 20 to 50%.
67. The catalyst of any of embodiments 61 to 63, wherein a portion of the third washcoat layer overlaps at least a portion of the second washcoat layer, wherein preferably the third washcoat layer overlaps the second washcoat layer over a portion ranging from 10 to 100% of the axial length of the second washcoat layer, more preferably from 15 to 80%, and more preferably from 20 to 50%.
68. The catalyst of embodiment 67, wherein the catalyst comprises a fourth washcoat layer, wherein the fourth washcoat layer is provided on the second layer, wherein the catalyst displays a zoned arrangement of the third and fourth washcoat layers, wherein the third washcoat layer is at least partially provided on the substrate along the axial length of the substrate starting from the inlet end of the substrate, and wherein the fourth washcoat layer is provided on the second washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the fourth washcoat layer.
69. The catalyst of embodiment 67, wherein the catalyst comprises a fourth washcoat layer, wherein the fourth washcoat layer is provided on the second layer, wherein the catalyst displays a zoned arrangement of the third and fourth washcoat layers, wherein the third washcoat layer is at least partially provided on the substrate along the axial length of the substrate starting from the outlet end of the substrate, and wherein the fourth washcoat layer is provided on the second washcoat layer along the axial length of the substrate starting from the inlet end of the substrate, wherein the length of the fourth washcoat layer is less than the axial length of the substrate such as to create an upstream zone comprising the fourth washcoat layer and a downstream zone comprising the third washcoat layer.
70. The catalyst of embodiment 68 or 69, wherein the third and fourth washcoat layers are adjacent to one another.
71. The catalyst of any of embodiments 1 to 46, wherein the catalyst comprises a third washcoat layer, wherein the catalyst displays a zoned arrangement of the first, second, and third washcoat layers, wherein the third washcoat layer is provided on the substrate along its axial length starting from the inlet end of the substrate and wherein the first washcoat layer is provided on the substrate along its axial length starting from the outlet end of the substrate, and wherein the second washcoat layer is provided on and entirely covers the first washcoat layer, wherein the length of the third washcoat layer is less than the axial length of the substrate such as to create an upstream zone comprising the third washcoat layer and a downstream zone comprising the first and second washcoat layers, and wherein the one or more platinum group metals are at least in part contained in the third washcoat layer.
72. The catalyst of any of embodiments 1 to 46, wherein the catalyst comprises a third washcoat layer, wherein the catalyst displays a zoned arrangement of the first, second, and third washcoat layers, wherein the third washcoat layer is provided on the substrate along its axial length starting from the outlet end of the substrate and wherein the first washcoat layer is provided on the substrate along its axial length starting from the inlet end of the substrate, and wherein the second washcoat layer is provided on and entirely covers the first washcoat layer, wherein the length of the third washcoat layer is less than the axial length of the substrate such as to create a downstream zone comprising the third washcoat layer and an upstream zone comprising the first and second washcoat layers, and wherein the one or more platinum group metals are at least in part contained in the third washcoat layer.
73. The catalyst of embodiment 71 or 72, wherein the first and third washcoat layers are adjacent to one another.
74. The catalyst of any of embodiments 71 to 73, wherein the second and third washcoat layers are adjacent to one another.
75. The catalyst of any of embodiments 71 to 73, wherein a portion of the first washcoat layer overlaps at least a portion of the third washcoat layer, wherein preferably the first washcoat layer overlaps the third washcoat layer over a portion ranging from 10 to 100% of the axial length of the third washcoat layer, more preferably from 15 to 80%, and more preferably from 20 to 50%.
76. The catalyst of any of embodiments 71 to 73, wherein a portion of the second washcoat layer overlaps at least a portion of the third washcoat layer, wherein preferably the second washcoat layer overlaps the third washcoat layer over a portion ranging from 10 to 100% of the axial length of the third washcoat layer, more preferably from 15 to 80%, and more preferably from 20 to 50%.
77. The catalyst of any of embodiments 71 to 73, wherein a portion of the third washcoat layer overlaps at least a portion of the second washcoat layer, wherein preferably the third washcoat layer overlaps the second washcoat layer over a portion ranging from 10 to 100% of the axial length of the second washcoat layer, more preferably from 15 to 80%, and more preferably from 20 to 50%.
78. The catalyst of embodiment 71, wherein the catalyst comprises a fourth washcoat layer, wherein the catalyst displays a zoned arrangement of the third and fourth washcoat layers, wherein the third washcoat layer is at least partially provided on the substrate along the axial length of the substrate starting from the inlet end of the substrate, and wherein the fourth washcoat layer is provided on the second washcoat layer along the axial length of the substrate starting from the outlet end of the substrate, wherein the length of the fourth washcoat layer is less than the axial length of the substrate such as to create an upstream zone comprising the third washcoat layer and a downstream zone comprising the fourth washcoat layer.
79. The catalyst of embodiment 72, wherein the catalyst comprises a fourth washcoat layer, wherein the catalyst displays a zoned arrangement of the third and fourth washcoat layers, wherein the third washcoat layer is at least partially provided on the substrate along the axial length of the substrate starting from the outlet end of the substrate, and wherein the fourth washcoat layer is provided on the second washcoat layer along the axial length of the substrate starting from the inlet end of the substrate, wherein the length of the fourth washcoat layer is less than the axial length of the substrate such as to create an upstream zone comprising the fourth washcoat layer and a downstream zone comprising the third washcoat layer.
80. The catalyst of embodiment 78 or 79, wherein the third and fourth washcoat layers are adjacent to one another.
81. The catalyst of any of embodiments 56 to 80, wherein the length of the first washcoat layer ranges from 5 to 100% of the axial length of the substrate, preferably from 10 to 90% of the axial length of the substrate, more preferably from 30 to 80%, more preferably from 45 to 75%, and more preferably from 50 to 70%.
82. The catalyst of any of embodiments 56 to 81, wherein the length of the second washcoat layer ranges from 5 to 100% of the axial length of the substrate, preferably from 10 to 90% of the axial length of the substrate, more preferably from 30 to 80%, more preferably from 45 to 75%, and more preferably from 50 to 70%.
83. The catalyst of any of embodiments 56 to 82, wherein the length of the third washcoat layer ranges from 10 to 90% of the axial length of the substrate, preferably from 30 to 80%, more preferably from 45 to 75%, and more preferably from 50 to 70%.
84. The catalyst of any of embodiments 56 to 82, wherein the length of the third washcoat layer ranges from 10 to 90% of the axial length of the substrate, preferably from 20 to 60%, and more preferably from 35 to 45%.
85. The catalyst of any of embodiments 53 to 84, wherein the catalyst comprises the fourth washcoat layer, wherein the length of the fourth washcoat layer ranges from 10 to 90% of the axial length of the substrate, preferably from 30 to 70%, more preferably from 45 to 55%, and more preferably from 49 to 51%.
86. The catalyst of any of embodiments 1 to 85, wherein the fourth washcoat layer is substantially free of a sulfur-trap material, wherein preferably the fourth washcoat layer is free of a sulfur-trap material.
87. The catalyst of any of embodiments 1 to 86, wherein the fourth washcoat layer comprises a hydrocarbon trap material, wherein the hydrocarbon trap material comprises a molecular sieve, preferably a zeolite, more preferably a zeolite having a maximum pore size of 12-membered rings, more preferably zeolite beta, wherein the molecular sieve, preferably the zeolite, preferably comprises SiO₂ and Al₂O₃, wherein the molecular sieve, preferably the zeolite, more preferably has a molar ratio of SiO₂ to Al₂O₃ in the range of from 10:1 to 500:1, more preferably of from 10:1 to 100:1, more preferably of from 10:1 to 40:1, more preferably of from 15:1 to 30:1, more preferably of from 20:1 to 25:1, wherein the molecular sieve, preferably the zeolite, preferably comprises Fe, wherein the molecular sieve, preferably the zeolite, more preferably comprises Fe, calculated as Fe₂O₃, in an amount in the range of from 1.0 to 7.0 weight-%, more preferably of from 3.0 to 5.0 weight-%, more preferably of from 4.0 to 4.5 weight-%, based on the weight of the molecular sieve.
88. The catalyst of embodiment 87, wherein the loading of the hydrocarbon trap material in the fourth washcoat layer is in the range of from 0.01 to 2.0 g/in³, preferably in the range of from 0.05 to 1.0 g/in³, more preferably in the range of from 0.05 to 0.3 g/in³.
89. The catalyst of any of embodiments 1 to 88, wherein the one or more platinum group metals are at least in part contained in the fourth washcoat layer.
90. The catalyst of embodiment 89, wherein the one or more platinum group metals are supported on a particulate support material, wherein the particulate support material is preferably selected from the group consisting of Al₂O₃, SiO₂, TiO₂, SiO₂-doped Al₂O₃, Mn oxide-doped Al₂O₃, and mixtures of two or more thereof, wherein preferably the one or more platinum group metals are supported on Al₂O₃ and/or SiO₂-doped Al₂O₃ and/or Mn oxide-doped Al₂O₃, more preferably SiO₂-doped Al₂O₃ or Al₂O₃ or Mn oxide-doped Al₂O₃, wherein the Mn oxide-doped Al₂O₃ preferably comprises from 1 to 10 weight-%, more preferably from 4 to 6 weight-%, of Mn oxide, calculated as MnO₂, based on 100 weight-% of the Mn oxide-doped Al₂O₃.
91. The catalyst of any of embodiments 1 to 90, wherein the catalyst comprises third and fourth washcoat layers, wherein the one or more platinum group metals are entirely contained in the third and fourth washcoat layers, wherein the weight ratio of the one or more platinum group metals comprised in the third washcoat layer to the one or more platinum group metals comprised in the fourth washcoat layer is in the range of from 0.5:1 to 5.0:1, more preferably 1.0:1 to 2.0:1, more preferably in the range of from 1.4:1 to 1.6:1, wherein the one or more platinum group metals comprised in the third washcoat layer preferably comprise, more preferably consist of, Pt and Pd, wherein the one or more platinum group metals comprised in the fourth washcoat layer preferably comprise, more preferably consist of, Pt and Pd.
92. The catalyst of any of embodiments 56 to 91, wherein the one or more platinum group metals are entirely contained in the third washcoat layer and/or in the optional fourth washcoat layer.
93. The catalyst of any of embodiments 1 to 92, wherein the substrate is a metallic substrate or a ceramic substrate, wherein preferably the substrate is a ceramic substrate, wherein more preferably the substrate comprises cordierite and/or SiC, preferably cordierite,
wherein more preferably, the substrate consists of cordierite and/or SiC, preferably of cordierite.
94. The catalyst of any of embodiments 56 to 93, wherein the substrate consists of two separate monoliths, wherein the first monolith is provided upstream of the second monolith, wherein the washcoat layer or washcoat layers of the upstream zone are contained on the first monolith, and the washcoat layer or washcoat layers of the downstream zone are contained on the second monolith, wherein preferably the first monolith containing the washcoat layer or washcoat layers of the upstream zone and the second monolith containing the washcoat layer or washcoat layers of the downstream zone are obtained or obtainable by sectioning of a catalyst according to any of embodiments 55 to 88 into two separate monoliths, wherein the washcoat layer or washcoat layers of the upstream zone are contained on the first monolith, and the washcoat layer or washcoat layers of the downstream zone are contained on the second monolith.
95. The catalyst of any of embodiments 1 to 94, wherein the exhaust gas stream contains hydrocarbons, preferably C1 to C20 hydrocarbons, more preferably 02 to 010 hydrocarbons.
96. Exhaust gas treatment system comprising an internal combustion engine and an exhaust gas conduit for exhaust gas from the internal combustion engine, wherein the exhaust gas conduit comprises one or more catalysts according to any of embodiments 1 to 95, preferably one, two, three or four catalysts according to any of embodiments 1 to 95.
97. The exhaust gas treatment system of embodiment 96, wherein the internal combustion engine is a compression ignition engine, preferably a diesel engine.
98. The exhaust gas treatment system of embodiment 96 or 97, wherein the internal combustion engine is a lean gasoline engine.
99. The exhaust gas treatment system of embodiment 96, wherein the internal combustion engine is powered by an oxygenated fuel, wherein the oxygenated fuel preferably comprises one or more of methanol and biofuel.
100. The exhaust gas treatment system of any of embodiments 96 to 99, wherein the system comprises one or more of an electric heater, a fuel burner, a fuel injector, a selective catalytic reduction (SCR) catalyst, an ammonia oxidation (AMOX) catalyst, a catalyzed soot filter (CSF), a diesel particulate filter (DPF), a selective catalytic reduction catalyst on filter (SCRoF), and a diesel exotherm catalyst (DEC).
101. The exhaust gas treatment system of embodiment 100, comprising in consecutive order in the direction of the exhaust gas: optionally an electric heater or a fuel burner and/or a fuel injector, a catalyst according to any of embodiments 1 to 95, a catalyst according to any of embodiments 1 to 95, a selective catalytic reduction (SCR) catalyst, a selective catalytic reduction (SCR) catalyst, an optional fuel injector, a diesel exotherm catalyst (DEC), a catalyzed soot filter (CSF), a selective catalytic reduction (SCR) catalyst, and a selective catalytic reduction (SCR) catalyst.
102. The exhaust gas treatment system of embodiment 100, comprising in consecutive order in the direction of the exhaust gas: optionally an electric heater or a fuel burner and/or a fuel injector, a catalyst according to any of embodiments 1 to 95, a catalyst according to any of embodiments 1 to 95, a selective catalytic reduction (SCR) catalyst, a selective catalytic reduction (SCR) catalyst, an optional fuel injector, a diesel exotherm catalyst (DEC), a diesel particulate filter (DPF), a selective catalytic reduction (SCR) catalyst, and a selective catalytic reduction (SCR) catalyst.
103. The exhaust gas treatment system of embodiment 100, comprising in consecutive order in the direction of the exhaust gas: optionally an electric heater or a fuel burner and/or a fuel injector, a catalyst according to any of embodiments 1 to 95, a catalyst according to any of embodiments 1 to 95, a selective catalytic reduction (SCR) catalyst, a selective catalytic reduction (SCR) catalyst, an optional fuel injector, a diesel exotherm catalyst (DEC), a diesel particulate filter (DPF), a selective catalytic reduction (SCR) catalyst, and an ammonia oxidation (AMOX) catalyst.
104. The exhaust gas treatment system of embodiment 100, comprising in consecutive order in the direction of the exhaust gas: optionally an electric heater or a fuel burner and/or a fuel injector, a catalyst according to any of embodiments 1 to 95, a catalyst according to any of embodiments 1 to 95, a selective catalytic reduction (SCR) catalyst, a selective catalytic reduction (SCR) catalyst, an optional fuel injector, a catalyst according to any of embodiments 1 to 95, a diesel particulate filter (DPF), a selective catalytic reduction (SCR) catalyst, and a selective catalytic reduction (SCR) catalyst.
105. The exhaust gas treatment system of embodiment 100, comprising in consecutive order in the direction of the exhaust gas: optionally an electric heater or a fuel burner and/or a fuel injector, a catalyst according to any of embodiments 1 to 95, a catalyst according to any of embodiments 1 to 95, a selective catalytic reduction (SCR) catalyst, a selective catalytic reduction (SCR) catalyst, an optional fuel injector, a catalyst according to any of embodiments 1 to 95, a catalyst according to any of embodiments 1 to 95, wherein the substrate is a wall-flow substrate, a selective catalytic reduction (SCR) catalyst, and an ammonia oxidation (AMOX) catalyst.
106. The exhaust gas treatment system of embodiment 100, comprising in consecutive order in the direction of the exhaust gas: optionally an electric heater or a fuel burner and/or a fuel injector, a catalyst according to any of embodiments 1 to 95, a selective catalytic reduction (SCR) catalyst, a selective catalytic reduction (SCR) catalyst, a catalyzed soot filter (CSF), a selective catalytic reduction (SCR) catalyst, and a selective catalytic reduction (SCR) catalyst.
107. The exhaust gas treatment system of embodiment 100, comprising in consecutive order in the direction of the exhaust gas: optionally an electric heater or a fuel burner and/or a fuel injector, a catalyst according to any of embodiments 1 to 95, a selective catalytic reduction (SCR) catalyst, a selective catalytic reduction (SCR) catalyst, a catalyzed soot filter (CSF), a selective catalytic reduction (SCR) catalyst, and an ammonia oxidation (AMOX) catalyst.
108. The exhaust gas treatment system of embodiment 100, comprising in consecutive order in the direction of the exhaust gas: optionally an electric heater or a fuel burner and/or a fuel injector, a catalyst according to any of embodiments 1 to 95, a selective catalytic reduction (SCR) catalyst, a selective catalytic reduction (SCR) catalyst, an optional fuel injector, a catalyst according to any of embodiments 1 to 95, wherein the substrate is a wall-flow substrate, a selective catalytic reduction (SCR) catalyst, and an ammonia oxidation (AMOX) catalyst.
109. The exhaust gas treatment system of embodiment 100, comprising in consecutive order in the direction of the exhaust gas: optionally an electric heater or a fuel burner and/or a fuel injector, a catalyst according to any of embodiments 1 to 95, a selective catalytic reduction (SCR) catalyst, a selective catalytic reduction catalyst on filter (SCRoF), and an ammonia oxidation (AMOX) catalyst.
110. The exhaust gas treatment system of embodiment 100, comprising in consecutive order in the direction of the exhaust gas: optionally an electric heater or a fuel burner and/or a fuel injector, a selective catalytic reduction (SCR) catalyst, an optional fuel injector, a catalyst according to any of embodiments 1 to 95, a selective catalytic reduction catalyst on filter (SCRoF), and an ammonia oxidation (AMOX) catalyst.
111. The exhaust gas treatment system of embodiment 100, comprising in consecutive order in the direction of the exhaust gas: optionally an electric heater or a fuel burner and/or a fuel injector, a selective catalytic reduction (SCR) catalyst, an optional fuel injector, a catalyst according to any of embodiments 1 to 95, a catalyzed soot filter (CSF), a selective catalytic reduction (SCR) catalyst, and an ammonia oxidation (AMOX) catalyst.
112. The exhaust gas treatment system of embodiment 100, comprising in consecutive order in the direction of the exhaust gas: optionally an electric heater or a fuel burner and/or a fuel injector, a selective catalytic reduction (SCR) catalyst, an optional fuel injector, a catalyst according to any of embodiments 1 to 95, a catalyst according to any of embodiments 1 to 95, wherein the substrate is a wall-flow substrate, a selective catalytic reduction (SCR) catalyst, and an ammonia oxidation (AMOX) catalyst.
113. The exhaust gas treatment system of embodiment 100, comprising in consecutive order in the direction of the exhaust gas: optionally an electric heater or a fuel burner and/or a fuel injector, a catalyst according to any of embodiments 1 to 95, a diesel particulate filter (DPF), a selective catalytic reduction (SCR) catalyst, a selective catalytic reduction (SCR) catalyst, a selective catalytic reduction (SCR) catalyst, a selective catalytic reduction (SCR) catalyst, and an ammonia oxidation (AMOX) catalyst.
114. The exhaust gas treatment system of embodiment 100, comprising in consecutive order in the direction of the exhaust gas: optionally an electric heater or a fuel burner and/or a fuel injector, a catalyst according to any of embodiments 1 to 95, a selective catalytic reduction catalyst on filter (SCRoF), a selective catalytic reduction (SCR) catalyst, and an ammonia oxidation (AMOX) catalyst.
115. The exhaust gas treatment system of embodiment 100, comprising in consecutive order in the direction of the exhaust gas: optionally an electric heater or a fuel burner and/or a fuel injector, a catalyst according to any of embodiments 1 to 95, a selective catalytic reduction (SCR) catalyst, a selective catalytic reduction catalyst on filter (SCRoF), a selective catalytic reduction (SCR) catalyst, and an ammonia oxidation (AMOX) catalyst.
116. Method for the treatment of an exhaust gas stream containing one or more of formaldehyde, nitrogen oxide (NO), and hydrocarbons, the method comprising
   (A) providing an exhaust gas stream comprising one or more of formaldehyde and hydrocarbons;
   (B) directing the exhaust gas stream provided in (A) through a catalyst according to any of embodiments 1 to 95.
117. The method of embodiment 116, wherein the exhaust gas stream provided in (A) comprises one or more sulfur-containing compounds, preferably SO₂ and/or SO₃.
118. The method of embodiment 116 or 117, wherein the exhaust gas stream provided in (A) comprises NOx.
119. The method of any of embodiments 116 to 118, wherein the exhaust gas stream provided in (A) comprises CO.
120. The method of any of embodiments 116 to 119, wherein the exhaust gas stream provided in (A) comprises hydrocarbons, preferably C1 to C20 hydrocarbons, more preferably C2 to C10 hydrocarbons.
121. Use of a catalyst according to any of embodiments 1 to 95 for the oxidation of one or more of formaldehyde, nitrogen oxide (NO), and hydrocarbons, preferably for the oxidation of one or more of formaldehyde, nitrogen oxide (NO), and hydrocarbons in an exhaust gas stream, more preferably for the oxidation of one or more of formaldehyde, nitrogen oxide (NO), and hydrocarbons in the exhaust gas stream of an internal combustion engine, more preferably for the oxidation of one or more of formaldehyde, nitrogen oxide (NO), and hydrocarbons in the exhaust gas stream of an internal combustion engine, more preferably for the oxidation of one or more of formaldehyde, nitrogen oxide (NO), and hydrocarbons in the exhaust gas stream of a compression ignition engine, more preferably for the oxidation of one or more of formaldehyde, nitrogen oxide (NO), and hydrocarbons in the exhaust gas stream of a diesel engine.

The present invention is further illustrated by the following examples and comparative examples.

### Experimental Section

### Comparative Example 1: Preparation of a Catalyst for the Treatment of an Exhaust Gas Stream Containing One or More of Formaldehyde, Nitrogen Oxide (NO), and Hydrocarbons

A catalyst was prepared by coating platinum group metal (PGM)-containing front zone and base metal oxide (BMO)-containing rear zone segments separately on 1″ diameter cordierite honeycomb substrates and then combining the coated cores sequentially for subsequent S aging and testing. The front zone segment was prepared by first combining Pt (using an aqueous solution containing an ammine stabilized hydroxo Pt(IV) complex, said solution having a Pt content in the range of from 10 to 20 weight-%), Pd (using Pd nitrate), Beta zeolite and a commercial alumina support powder comprising 5 wt.-% silica and having a BET surface area of approximately 150 m²/g and a pore volume of about 0.6 cm³/g in an aqueous slurry composition using techniques commonly known in the art. After coating the slurry onto a cordierite substrate followed by drying and calcination at 590° C., a 1″ diameter by 1.2″ long core was subsequently cut from the monolith to be used as the front zone segment. Pt-Pd weight ratio was 2:1, and total Pt-Pd loading was 75 g/ft³ of monolith volume. The washcoat loading of the PGM-containing layer was 2.9 g/in³, containing about 91 wt.-% alumina and about 9 wt.-% Beta zeolite. The BMO-containing rear zone segment was prepared by first combining a commercial zirconia support powder comprising 9 wt.-% La₂O₃ and having a BET surface area of approximately 75 m²/g with solutions of Mn nitrate and Ce nitrate in de-ionized (Di) water. After milling the resulting mixture to a particle size suitable for coating, boehmite alumina binder was added. The resulting slurry was then coated onto a 1″ diameter by 1.8″ long cordierite substrate which was dried and subsequently calcined at 590° C. for 1 h. The total washcoat loading of the BMO-containing layer was 2.3 g/in³ of monolith volume comprising 9.2% by weight Mn, 9.2% by weight Ce, 3% by weight alumina binder and balance La₂O₃-stabilized ZrO₂.

### Example 2: Preparation of a Catalyst for the Treatment of an Exhaust Gas Stream Containing One or More of Formaldehyde, Nitrogen Oxide (NO), and Hydrocarbons

A catalyst was prepared identically to that described in Comparative Example 1 except that a topcoat comprising Fe₂O₃—Al₂O₃(comprising 30% by weight Fe₂O₃) was applied over the Mn-containing rear zone segment. The topcoat was prepared by first dispersing a commercial alumina support powder having a BET surface area of approximately 150 m²/g and a pore volume of about 0.5 cm³/g in de-ionized (DI) water. After milling the resulting mixture to a particle size suitable for coating, Fe₂O₃ powder with a particle size less than 5 μm and boehmite alumina binder were added. The resulting slurry was then coated onto the 1″ diameter by 1.8″ long cordierite substrate previously coated with the Mn-containing composition, dried and subsequently calcined at 590° C. for 1 h. Total washcoat loading of the topcoat was 1.0 g/in³ of monolith volume comprising 29% by weight Fe₂O₃, 3% by weight Al₂O₃ binder and balance Al₂O₃ support.

### Example 3: Preparation of a Catalyst for the Treatment of an Exhaust Gas Stream Containing One or More of Formaldehyde, Nitrogen Oxide (NO), and Hydrocarbons

A catalyst was prepared in the same manner as described in Example 2 except that a topcoat comprising La₂O₃—ZrO₂ (comprising 9% by weight La₂O₃) was applied over the Mn-containing rear zone segment instead of Fe₂O₃—Al₂O₃. The topcoat was prepared by first dispersing the same 9 wt.-% La₂O₃—ZrO₂ support powder used to make the bottom coat in de-ionized (DI) water, milling the resulting mixture to a particle size suitable for coating, and then adding boehmite alumina binder. The resulting slurry was then coated onto a 1″ diameter by 1.8″ long cordierite substrate previously coated with the Mn-containing composition, dried and subsequently calcined at 590° C. for 1 h. Total washcoat loading of the topcoat was 1.0 g/in³ of monolith volume comprising 3% by weight Al₂O₃ binder and balance La₂O₃-stabilized ZrO₂.

### Example 4: Preparation of a Catalyst for the Treatment of an Exhaust Gas Stream Containing One or More of Formaldehyde, Nitrogen Oxide (NO), and Hydrocarbons

A catalyst was prepared similarly to that described in Example 3 except that no Ce was added to the bottom coat and that Fe₂O₃ was added to the topcoat. The total washcoat loading of the bottom coat was 2.8 g/in³ of monolith volume comprising 10% by weight Mn, 3% by weight alumina binder and balance La₂O₃-stabilized ZrO₂. The total washcoat loading of the topcoat was 1.0 g/in³ of monolith volume comprising 48.5% by weight Fe₂O₃, 48.5% by weight La₂O₃-stabilized ZrO₂ and 3% by weight Al₂O₃ binder.

### Example 5: Preparation of a Catalyst for the Treatment of an Exhaust Gas Stream Containing One or More of Formaldehyde, Nitrogen Oxide (NO), and Hydrocarbons

A catalyst was prepared comprising three layers covering the entire 3″ length of the substrate, rather than in two adjacent zones. The bottom layer comprising 10 wt.-% Mn and 10 wt.-% Ce supported on 9 wt.-% La₂O₃-stabilized ZrO₂ and the middle layer comprising 29 wt.-% Fe₂O₃ supported on Al₂O₃ were prepared in the same manner as the two coats in the rear zone of the catalyst according to Example 2. The topcoat comprising Pt-Pd supported on 5 wt.-% SiO₂—Al₂O₃ was prepared in the same manner as the front zone of the catalysts according to Examples I-4 except that no Beta zeolite was included. The total washcoat loading of the topcoat was 1.2 g/in³, the Pt-Pd weight ratio was 2:1, and the total Pt-Pd loading was 30 g/ft³ of monolith volume.

### Comparative Example 6: Preparation of a Catalyst for the Treatment of an Exhaust Gas Stream Containing One or More of Formaldehyde, Nitrogen Oxide (NO), and Hydrocarbons

A catalyst was prepared by coating PGM-containing front zone and BMO-containing rear zone segments separately on 1″ diameter cordierite honeycomb substrates and then combining the coated cores sequentially for subsequent S aging and testing. The 1.2″ long front zone segment was prepared in the same manner as described in Comparative Example 1. The 1.8″ long BMO-containing rear zone segment was prepared by first combining a commercial zirconia support powder comprising 9 wt.-% La₂O₃ and having a BET surface area of approximately 75 m²/g with solutions of Mn nitrate, Cu nitrate and Ce nitrate in de-ionized (Di) water. After milling the resulting mixture to a particle size suitable for coating, boehmite alumina binder was added. The resulting slurry was then coated onto a 1″ diameter by 1.8″ long cordierite substrate which was dried and subsequently calcined at 590° C. for 1 h. The total washcoat loading was 1.9 g/in³ of monolith volume comprising 8.7% by weight Mn, 8.7% by weight Cu, 8.7% by weight Ce, 3% by weight Al₂O₃ binder and balance La₂O₃-stabilized ZrO₂.

### Example 7: Preparation of a Catalyst for the Treatment of an Exhaust Gas Stream Containing One or More of Formaldehyde, Nitrogen Oxide (NO), and Hydrocarbons

A catalyst was prepared in the same manner as described in Comparative Example 6 except that a topcoat comprising 9% by weight La₂O₃ supported on ZrO₂ was applied over the Mn-containing rear zone segment. The topcoat was prepared in the same manner as the topcoat described in Example 3. The total washcoat loading of the topcoat was 1.1 g/in³ of monolith volume comprising 3% by weight Al₂O₃ binder and balance La₂O₃-stabilized ZrO₂.

### Example 8: Preparation of a Catalyst for the Treatment of an Exhaust Gas Stream Containing One or More of Formaldehyde, Nitrogen Oxide (NO), and Hydrocarbons

A catalyst was prepared in the same manner as described in Comparative Example 6 except that a topcoat was applied over the Mn-containing rear zone segment, the topcoat comprising 0.1 wt.-% Pt impregnated onto 9% by weight La₂O₃ supported on ZrO₂ prior to dispersing in water, milling and coating over the Mn-containing bottom coat. The Pt loading over the 1.8″ long rear zone core was 2 g/ft² of monolith volume.

### Example 9: Preparation of a Catalyst for the Treatment of an Exhaust Gas Stream Containing One or More of Formaldehyde, Nitrogen Oxide (NO), and Hydrocarbons

A catalyst was prepared in the same manner as described in Comparative Example 1 except that a topcoat comprising 10 wt.-% La₂O₃ supported on a commercial rare earth oxide doped CeO₂—ZrO₂ was applied over the Mn-containing rear zone segment. The topcoat was prepared by first dispersing the ceria-zirconia support powder comprising 22 wt.-% CeO₂, 68 wt.-% ZrO₂, 5 wt.-% La₂O₃, 3 wt.-% Y₂O₃ and 2 wt.-% Nd₂O₃ and having a BET surface area of approximately 80 m²/g in de-ionized (DI) water. After milling the resulting mixture to a particle size suitable for coating, lanthanum nitrate and zirconium acetate binder were added. The resulting slurry was then coated onto the 1″ diameter by 1.8″ long cordierite substrate previously coated with the Mn-containing composition, dried and subsequently calcined at 590° C. for 1 h. Total washcoat loading of the topcoat was 2.1 g/in³ of monolith volume comprising 10% by weight added La₂O₃, 2.4% by weight ZrO₂ binder and balance rare earth oxide doped CeO₂—ZrO₂ support.

### Example 10: Preparation of a Catalyst for the Treatment of an Exhaust Gas Stream Containing One or More of Formaldehyde, Nitrogen Oxide (NO), and Hydrocarbons

A catalyst was prepared in the same manner as described in Example 9 except that the rare earth oxide doped CeO₂—ZrO₂ support used in the topcoat of the rear zone segment comprised 86 wt.-% CeO₂, 10 wt.-% ZrO₂ and 4 wt.-% La₂O₃. The total washcoat loading of the topcoat was 2.1 g/in³ of monolith volume comprising 10% by weight added La₂O₃, 3% by weight ZrO₂ binder and balance rare earth oxide doped CeO₂—ZrO₂ support.

### Example 11: Preparation of a Catalyst for the Treatment of an Exhaust Gas Stream Containing One or More of Formaldehyde, Nitrogen Oxide (NO), and Hydrocarbons

A catalyst was prepared in the same manner as described in Example 2 except that the front and rear zones were reversed (i.e., the Mn-containing zone was placed in the front and the Pt—Pd-containing zone was placed in the rear).

### Example 12: Catalyst Aging and Catalytic Testing

Sulfur aging (S aging) of the catalysts of Comparative Examples 1 and 6 as well as of Examples 2-5, 7-8 and 11 was accomplished by exposing the catalysts to the exhaust of a diesel engine operating with fuel containing 325 ppm S by weight. 1″×3 catalyst core samples were loaded into a ceramic monolith holder and placed in the flow of the engine exhaust downstream of a burner DOC used to raise the exhaust temperature for periodic desulfation events. During sulfation, the exhaust temperature at the inlet to the catalyst core samples was maintained at 315° C., and flow through the catalyst measured as space velocity was 61,000/h. The exposure time at this condition was 180 minutes corresponding to a target S exposure amount of 2 g (S)/L of monolith volume. Desulfation was accomplished by raising the temperature in front of the catalyst core samples to 650 or 700° C. for 30 minutes by injecting diesel fuel in front of the burner DOC upstream of the catalysts. Overall, 5 complete sulfation and desulfation cycles were accomplished.

After sulfation and desulfation, samples were tested for formaldehyde (HCHO) light-off performance using a feed comprising 180 ppm NO, 1000 ppm CO, 25 ppm HCHO, 100 ppm-C1 from C₂H₄, 190 ppm-C1 from C₁₀H₂₂, 10% O₂, 10% H₂O and 10% CO₂. The flow through the catalyst as measured by space velocity was 50,000/h. The samples were placed in the reactor and first equilibrated at 80° C. in flowing air. The formaldehyde-containing feed was then introduced and temperature ramping initiated to 300° C. at a ramp rate of 15° C./min. Formaldehyde concentration was monitored by FTIR during the light-off ramp and conversion performance vs. temperature was subsequently calculated from these measurements.

The results after 650° C. desulfation for the catalysts of Comparative Example 1 and Examples 2-3 are shown in FIG. 3. The formaldehyde oxidation performance was higher for the catalyst of Example 2-3 utilizing S-adsorbent top layers in the rear zone comprising either 29 wt.-% Fe₂O₃—Al₂O₃ or 9 wt.-% La₂O₃—ZrO₂, respectively. Highest performance was achieved with Example 2 comprising the 29 wt.-% Fe₂O₃—Al₂O₃ topcoat.

The results after 700° C. desulfation for the catalysts of Comparative Example 1 and Examples 2, 4 and 5 are shown in FIG. 4. The formaldehyde oxidation performance was higher after sulfation/desulfation for the catalysts of Examples 2, 4 and 5 comprising a S-adsorbent layer coated over the Mn-containing layer. Highest performance was achieved by the catalysts of Examples 2 and 5 comprising a mixture of Fe₂O₃ and Al₂O₃ in the S-adsorbent layer.

The results after 700° C. desulfation for Comparative Example 6, and Examples 7-8 are shown in FIG. 5. The formaldehyde oxidation performance was higher after sulfation/desulfation for the catalysts of Examples 7-8 utilizing S-adsorbent top layers in the rear zone comprising either 9 wt.-% La₂O₃—ZrO₂ or 0.1 wt.-% Pt doped on 9 wt.-% La₂O₃—ZrO₂, respectively. Highest performance was achieved with the Pt-doped topcoat.

The results after 700° C. desulfation for Comparative Example 1, and Example 11 are shown in FIG. 7. The formaldehyde oxidation performance was higher after sulfation/desulfation for the catalyst of Example 11 with the Mn-containing zone further comprising the S adsorbent top layer in the front and the Pt-Pd zone in the rear.

### Example 13: Catalyst Aging and Catalytic Testing

Sulfur aging (S aging) of the catalysts of Comparative Examples 1 and Examples 2, 9 and 10 was accomplished on a lab reactor at 300° C. in a feed comprising 15 ppm SO₂, 150 ppm NO, 10% O₂ and 5% H₂O. The flow through the catalyst measured as space velocity was 35,000/h. Exposure time was 88 minutes corresponding to a target S exposure amount of 1 g (S)/L of monolith volume. Desulfation was accomplished at 650° C. under isothermal conditions for 30 minutes in a feed comprising 10% O₂ and 5% H₂O. Flow through the catalyst as measured by space velocity was 32,000/h. After sulfation and desulfation, samples were tested for formaldehyde (HCHO) light-off performance as described above. The results are shown in FIG. 6. Performance was much higher for all three catalysts of Examples 2, 9-10 comprising the S-adsorbent top layer.

### Example 14: Preparation of a Catalyst for the Treatment of an Exhaust Gas Stream Containing One or More of Formaldehyde, Nitrogen Oxide (NO), and Hydrocarbons

Catalyst samples were prepared in the same manner as described in Example 5 but on two 6.5″ diameter honeycomb monoliths with lengths of either 3.25″ or 4.75″. Catalyst compositions for both coated monoliths were identical with Pt-Pd loading of 30 g/ft³ on each. Average Pt-Pd loading over the two coated catalysts thus was also 30 g/ft³.

### Example 15: Preparation of a Catalyst for the Treatment of an Exhaust Gas Stream Containing One or More of Formaldehyde, Nitrogen Oxide (NO), and Hydrocarbons

Catalyst samples were prepared in the same manner as described in Example 14 except that Pt-Pd loading on the shorter coated monolith was 50 g/ft³ and Pt-Pd loading on the longer coated monolith was 30 g/ft³. Average Pt-Pd loading over the two coated catalysts was 38 g/ft³.

### Example 16: Preparation of a Catalyst for the Treatment of an Exhaust Gas Stream Containing One or More of Formaldehyde, Nitrogen Oxide (NO), and Hydrocarbons

Catalyst samples were prepared in the same manner as described in Example 14 except that Pt-Pd loading of the shorter coated monolith was 75 g/ft³ and Pt-Pd loading on the longer coated monolith was 30 g/ft³. Average Pt-Pd loading over the two coated catalysts was 48 g/ft³.

### Comparative Example 17: Preparation of a Catalyst for the Treatment of an Exhaust Gas Stream Containing One or More of Formaldehyde, Nitrogen Oxide (NO), and Hydrocarbons

Catalyst samples comprising only PGM (i.e., no BMO) were prepared on two 6.5″ diameter honeycomb monoliths with lengths of either 3.25″ or 4.75″ in the same manner as the front zone described in Comparative Example 1. Pt-Pd loading of the shorter monolith was 150 g/ft³ and Pt—Pd loading on the longer coated monolith was 105 g/ft³. Average Pt-Pd loading over the two coated catalysts was 123 g/ft³.

### Example 18: Catalyst Aging and Catalytic Testing

The coated monolith pairs of Examples 14-16 and Comparative Example 17 were subjected to sequential steady-state high-temperature and sulfur aging on a diesel engine. High temperature aging was accomplished for 50 h by separately placing each pair (shorter in front of longer) in the exhaust flow downstream of the engine, operating the engine to achieve an inlet temperature of approximately 300° C. to the first catalyst, injecting sufficient diesel fuel in front of the first catalyst to achieve a temperature of 700° C. at the outlet of the second catalyst, and then maintaining this condition for a total of 50 h.

After high temperature aging, cyclic sulfation and desulfation aging of the catalysts was accomplished by separately placing each pair (shorter in front of longer) in the exhaust flow downstream of the diesel engine and operating the engine with fuel containing 206 ppm S by weight. During sulfation, the exhaust temperature at the inlet to the first catalyst downstream of the engine was maintained at 315° C. This condition was maintained until target S exposure amount of 2 g (S)/L of the total volume of the two coated monoliths was achieved. Desulfation was accomplished by injecting sufficient diesel fuel in front of the first catalyst to achieve a temperature of 700° C. at the outlet of the second catalyst, and then maintaining this condition for a total of 30 minutes. Overall, 10 complete sulfation-desulfation cycles were accomplished corresponding to approximately 20,000 miles of on-road driving. Combined high-temperature and sulfation-desulfation aging was accomplished similarly for the coated monolith pair of Comparative Example 17 with the following differences: for the high temperature portion, the aging temperature was 750° C. and the aging time was 86 h; for the sulfation-desulfation portion, the number of cycles was 20 (about 40,000 mile on-road driving equivalent).

After the sequential high-temperature and sulfation-desulfation aging, the coated monolith pairs from Examples 14-16 and Comparative Example 17 were tested for catalyst performance on a 6.7 L diesel engine. The catalyst samples were mounted in the exhaust of the engine, and HCHO, CO, hydrocarbon (HC), NO and NO₂ emissions at the outlet of the second catalyst were monitored while operating the industry standard FTP-75 emissions testing cycle. All examples comprise two catalyst-coated monoliths, and in most cases, the PGM-loading of the first coated monolith is higher than that of the second. While Comparative Example 17 comprises only PGM, Examples 14-16 comprise both BMO and PGM with a much lower total PGM loading than Comparative Example 17. All BMO examples include a S-adsorbent layer comprising 30% Fe₂O₃—Al₂O₃ coated over the Mn-containing catalyst layer. Results are summarized in Table 1 below.

TABLE 1
HCHO, HC and NO₂/NOx emission results as measured during the FTP-75 emissions
certification cycle after combined high temperature and sulfation-desulfation
aging for Examples 14-16 and Comparative Example 17.

| | | | | | NO₂/NOx |
|---|---|---|---|---|---|
| | | | HCHO | NMHC | average |
| | | Aging | (weighted | (weighted | (Phase 1 + 2, |
| DOC1 | DOC2 | conditions | mg/mile) | mg/mile) | 4-23 min) |
| Ex. 14 | Ex. 14 | 700° C. DOC2 | 8.2 | 130.6 | 0.22 |
| (3.25″ long, 30 | (4.75″ long, 30 | out (50 h) + | | | |
| g/ft³ PGM) | g/ft³ PGM) | 20,000 miles | | | |
| | | S/de-S (700° C. | | | |
| | | de-S) | | | |
| Ex. 15 | Ex. 15 | 700° C. DOC2 | 6.6 | 105.4 | 0.23 |
| (3.25″ long, 50 | (4.75″ long, 30 | out (50 h) + | | | |
| g/ft³ PGM) | g/ft³ PGM) | 20,000 miles | | | |
| | | S/de-S (700° C. | | | |
| | | de-S) | | | |
| Ex. 16 | Ex. 16 | 700° C. DOC2 | 3.8 | 85.5 | 0.25 |
| (3.25″ long, 75 | (4.75″ long, 30 | out (50 h) + | | | |
| g/ft³ PGM) | g/ft³ PGM) | 20,000 miles | | | |
| | | S/de-S (700° C. | | | |
| | | de-S) | | | |
| Comp. Ex. 17 | Comp. Ex. 17 | 750° C. DOC2 | 11.3 | 92.8 | 0.13 |
| (3.25″ long, | (4.75″ long, | out (86 h) + | | | |
| 150 g/ft³ PGM) | 105 g/ft³ PGM) | 40,000 miles | | | |
| | | S/de-S (700° C. | | | |
| | | de-S) | | | |

Despite the somewhat harsher aging conditions used for the PGM-only Comparative Example 17, the benefit of the BMO catalyst with S trap layer was very significant. As expected, weighted FTP-75 HCHO oxidation emissions for all three BMO DOC catalyst combinations were lower vs. Comparative Example 17, even at the lowest average PGM loading of 30 g/ft³ for Example 14 (vs. 123 g/ft³ for Comparative Example 17). However, hydrocarbon (HC) oxidation performance was also surprisingly enhanced for the BMO catalysts. In particular, total weighted FTP-75 HC emissions were lower for Example 16 with less than half the average total PGM loading vs. Comparative Example 17. Similarly, NO oxidation performance was significantly enhanced with the BMO catalysts of Examples 14-16. NO₂/NOx ratio measured for all 3 BMO catalyst pairs after warmup during Phases 1 and 2 of the FTP-75 test cycle was almost twice that of PGM-only Comparative Example 17. Even BMO Example 14 with 4 times less PGM performed better. It is clear that inclusion of the BMO catalyst with S-adsorbent layer can allow for a significant reduction in the PGM content of diesel oxidation catalysts.

### Comparative Example 19: Preparation of a Catalyst for the Treatment of an Exhaust Gas Stream Containing One or More of Formaldehyde, Nitrogen Oxide (NO), and Hydrocarbons

A zoned catalyst sample comprising only PGM (i.e., no BMO) was prepared in the same manner as the front zone of Comparative Example 1. The front and rear zones both contained PGM while BMO and zeolite were excluded. For the 1.2″ front zone, Pt-Pd loading was 60 g/ft³ and the weight ratio of Pt to Pd was 4 to 1. For the 1.8″ rear zone, Pt-Pd loading was 10 g/ft³ and the weight ratio of Pt to Pd was 5 to 1. Average Pt-Pd loading including the combined front and rear zones was 30 g/ft³ and the average weight ratio of Pt to Pd was 4.6 to 1.

### Example 20: Catalyst Testing for Fuel Burning Light-Off Performance

Prior to testing for fuel burning light-off performance, catalyst-coated samples from Example 2 and Comparative Examples 6 and 19 were subjected to sequential hydrothermal, sulfation and desulfation aging. Hydrothermal aging was first accomplished in a lab reactor at 650° C. for 50 h in the presence of 10% steam/air. Gas flow through the catalyst expressed as space velocity was 31,000/h. Subsequently, the catalyst samples were subjected to sulfation and desulfation on a lab reactor as described in Example 13. Fuel burning performance was then measured on a laboratory reactor using a reactant gas composition comprising 1% diesel fuel (10,000 ppm Cl), 1000 ppm NO, 10% O₂, and 8% H₂O. The inlet temperature to the catalyst was ramped from 210° C. to 450° C. at 10° C./min while the temperature and hydrocarbon concentration of the gases exiting the catalyst were monitored. Gas flow through the catalyst expressed as space velocity was 104,000/h.

As shown in FIG. 8, although light-off of diesel fuel was faster for PGM-only Comparative Example 19, HC slip at temperatures greater than 330° C. was lower for the BMO-containing Examples 2 and 6. This is a significant advantage since it allows vehicle manufacturers to lower vehicle HC emissions, thereby making it easier to meet more stringent emission regulations.

It has been demonstrated that relative to a state-of-the-art reference Pt-Pd catalyst, fuel-burning light-off performance is improved after combined high temperature (650° C.) and sulfation-desulfation aging when the DOC composition comprises both a platinum group metal (PGM) and a base metal oxide catalyst. In particular, it has been found that hydrocarbon slip is lower for the BMO-containing catalyst. This enables vehicle manufacturers to meet ever tightening vehicle emissions standards while also reducing overall PGM usage and costs.

Furthermore, as shown in FIG. 9, the exotherm generated during light-off of 1% diesel fuel was significantly higher when the Mn-based BMO (base metal oxide) rear zone of Example 2 was combined with the Pt-Pd front zone compared to when the Pt-Pd front zone was tested by itself. Example 2 comprises both PGM (front zone) and Mn-based BMO (rear zone). This demonstrates that BMO has significant HC oxidation activity during conditions typically used for regeneration of diesel particulate filters (DPF) or catalyzed soot filters (CSF). This is a significant advantage since it allows vehicle manufacturers to reduce PGM usage and cost while at the same time satisfying more stringent emission regulations.

### Example 21: Preparation of a Catalyst for the Treatment of an Exhaust Gas Stream Containing One or More of Formaldehyde, Nitrogen Oxide (NO), and Hydrocarbons

A catalyst was prepared comprising four layers covering the entire 3.3″ length of the substrate.

The bottom layer was provided on a cordierite substrate over its total length. The bottom layer was prepared as the BMO-containing layer in the rear zone of the catalyst according to Comparative Example 1, thus, comprising 10 wt.-% Mn and 10 wt.-% Ce supported on 9 wt.-% La₂O₃-stabilized ZrO₂, wherein a washcoat loading of 0.9 g/in³ was applied.

The middle layer was provided on the bottom layer over its total length. The middle layer was prepared as the topcoat in the rear zone of the catalyst according to Example 2, thus, comprising 29 wt.-% Fe₂O₃ supported on Al₂O₃. The washcoat loading of the middle layer was 0.5 g/in³, containing 0.15 g/in³ of Fe₂O₃ and 0.35 g/in³ of Al₂O₃.

The inlet top coat layer was prepared by first combining Pt (using an aqueous solution containing an ammine stabilized hydroxo Pt(IV) complex, said solution having a Pt content in the range of from 10 to 20 weight-%), Pd (using Pd nitrate), Fe-containing zeolite beta and a commercial alumina support powder having a BET surface area of approximately 150 m²/g and a pore volume of about 1.0 cm³/g in an aqueous slurry composition using techniques commonly known in the art. The used zeolite beta had a molar silica-to-alumina ratio of 23:1 and a crystallinity vs. standard (XRD) greater than 90%. The Fe content, calculated as Fe₂O₃ of the Fe-containing zeolite beta was 4.3 weight-%, based on the weight of the zeolite beta. The inlet topcoat was provided on the middle layer from the inlet side of the substrate over a length of 50% of the length of the substrate. After coating the slurry onto the substrate, drying and calcination at 590° C. was performed. Pt-Pd weight ratio was 2.5:1, and total Pt-Pd loading was 126.5 g/ft³. The washcoat loading of the inlet topcoat PGM-containing layer was 1.8 g/in³, containing 1.0 g/in³ of Pt-Pd supported on alumina and 0.8 g/in³ of Fe-containing zeolite beta.

The outlet top coat layer was prepared by first combining Pt (using an aqueous solution containing an ammine stabilized hydroxo Pt(IV) complex, said solution having a Pt content in the range of from 10 to 20 weight-%), Pd (using Pd nitrate), and a commercial alumina support powder having a BET surface area of approximately 150 m²/g and a pore volume of about 0.75 cm³/g and comprising 5 weight-% Mn oxide in an aqueous slurry composition using techniques commonly known in the art. The outlet topcoat was provided on the middle layer from the outlet side of the substrate over a length of 50% of the length of the substrate. After coating the slurry onto the substrate, drying and calcination at 590° C. was performed. Pt-Pd weight ratio was 13.4:1, and total Pt-Pd loading was 83 g/ft³. The washcoat loading of the outlet topcoat PGM-containing layer was 1.0 g/in³.

### Example 22: Preparation of a Catalyst for the Treatment of an Exhaust Gas Stream Containing One or More of Formaldehyde, Nitrogen Oxide (NO), and Hydrocarbons

A catalyst was prepared comprising four layers.

The bottom layer was provided on a cordierite substrate from the outlet side over 70% of its total length. The bottom layer was prepared as the bottom layer in in Example 21, but with an applied washcoat loading of 1.3 g/in³.

The middle layer was provided on the bottom layer from the outlet side over 70% of the total length of the substrate. The middle layer was prepared as the middle layer in Example 21 comprising 29 wt.-% Fe₂O₃ supported on Al₂O₃ but with an applied washcoat loading of 0.73 g/in³, containing 0.22 g/in³ of Fe₂O₃ and 0.51 g/in³ of Al₂O₃.

The inlet topcoat layer was prepared as that according to Example 21. The inlet topcoat was provided from the inlet side of the substrate over a length of 50% of the length of the substrate, thus, covering a portion of the substrate and a portion of the middle layer. Pt-Pd weight ratio was 2.5:1, and total Pt-Pd loading was 126.5 g/ft³. The washcoat loading of the inlet topcoat PGM-containing layer was 1.8 g/in³, containing 1.0 g/in³ of Pt-Pd supported on alumina and 0.8 g/in³ of Fe-containing zeolite beta.

The outlet topcoat layer was prepared as that according to Example 21.

### Example 23: Preparation of a Catalyst for the Treatment of an Exhaust Gas Stream Containing One or More of Formaldehyde, Nitrogen Oxide (NO), and Hydrocarbons

A catalyst was prepared comprising four layers.

The bottom layer was provided on a cordierite substrate from the outlet side over 50% of its total length. The bottom layer was prepared as the bottom layer in Example 21, but with an applied washcoat loading of 1.8 g/in³.

The middle layer was provided on the bottom layer from the outlet side over 50% of the total length of the substrate. The middle layer was prepared as the middle layer in Example 21 comprising 29 wt.-% Fe₂O₃ supported on Al₂O₃ but with an applied washcoat loading of 1.0 g/in³, containing 0.3 g/in³ of Fe₂O₃ and 0.7 g/in³ of Al₂O₃.

The inlet topcoat layer was prepared as that according to Example 21. The inlet topcoat was provided from the inlet side of the substrate over a length of 50% of the length of the substrate, thus, covering a portion of the substrate. Pt-Pd weight ratio was 2.5:1, and total Pt-Pd loading was 126.5 g/ft³. The washcoat loading of the inlet topcoat PGM-containing layer was 2.3 g/in³, containing 1.5 g/in³ of Pt-Pd supported on alumina and 0.8 g/in³ of Fe-containing zeolite beta.

The outlet topcoat layer was prepared as that according to Example 21.

### DESCRIPTION OF THE FIGURES

FIG. 1: shows thermogravimetric (TG) curves for sulfates of divalent metals in flowing high purity nitrogen at a heating rate of 2° C./min (Tagawa, H., Thermochimica Acta, [80], 1984, 23-33).

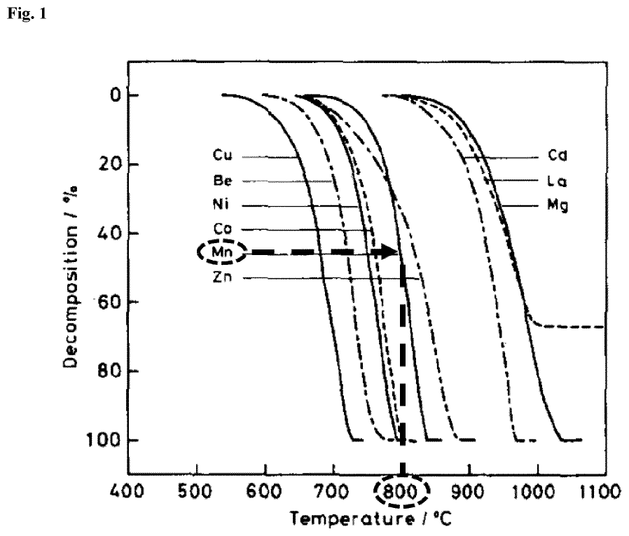

FIG. 2: shows thermogravimetric (TG) curves for sulfates of trivalent and tetravalent metals in flowing high purity nitrogen at a heating rate of 2° C./min (Tagawa, H., Thermochimica Acta, [80], 1984, 23-33).

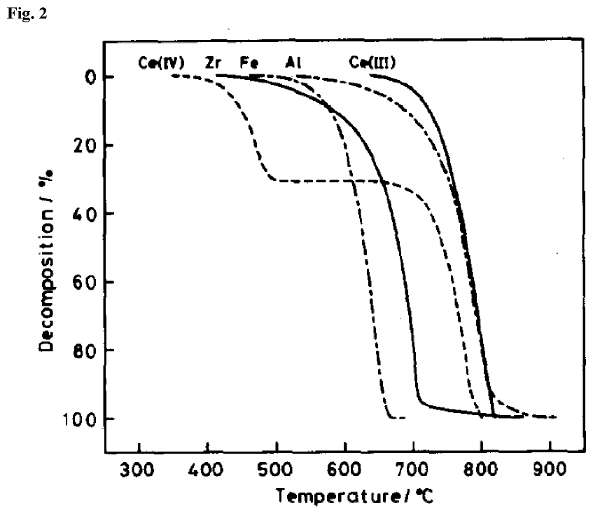

FIG. 3: shows formaldehyde (HCHO) oxidation performance after sulfation and 650° C. desulfation for the catalysts of Comparative Example 1 and Examples 2 and 3. All samples comprised a 2:1 Pt-Pd front zone at 75 g/ft³ and a rear zone comprising 10 wt.-% Mn and 10 wt.-% Ce supported on 9 wt.-% La₂O₃-stabilized ZrO₂. Additionally, the catalyst of Example 2 had a S-adsorbent layer comprising 29 wt.-% Fe₂O₃—Al₂O₃ coated over the Mn-containing catalyst layer in the rear zone, while Example 3 had a S-adsorbent layer comprising 9% La₂O₃—ZrO₂ coated over the Mn-containing layer in the rear zone.

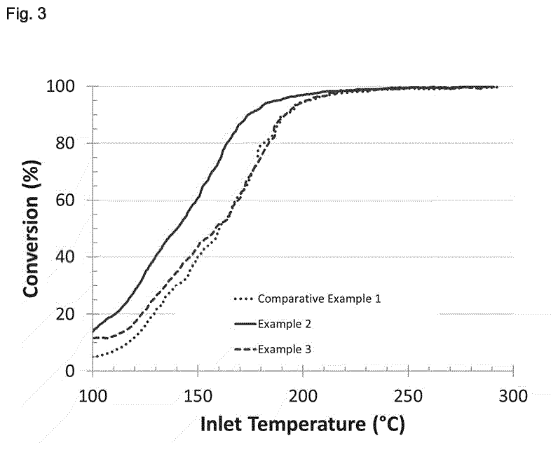

FIG. 4: shows formaldehyde (HCHO) oxidation performance after sulfation and 700° C. desulfation for the catalysts of Comparative Example 1 and Examples 2, 4 and 5. Example 2 comprised a 2:1 Pt-Pd front zone at 75 g/ft³ and a double coat rear zone comprising 10 wt.-% Mn and 10 wt.-% Ce supported on 9 wt.-% La₂O₃-stabilized ZrO₂ in the bottom layer and 29 wt.-% Fe₂O₃ supported on Al₂O₃ in the top layer. Example 4 comprised a 2:1 Pt-Pd front zone at 75 g/ft³ and a rear zone comprising 10 wt.-% Mn supported on 9 wt.-% La₂O₃-stabilized ZrO₂ in the bottom coat and 48.5 wt.-% Fe₂O₃ supported on 9 wt.-% La₂O₃-stabilized ZrO₂ in the topcoat. Example 5 had three layers with the bottom layer comprising 10 wt.-% Mn and 10 wt.-% Ce supported on 9 wt.-% La₂O₃-stabilized ZrO₂, the middle layer comprising 29 wt.-% Fe₂O₃ supported on Al₂O₃, and the top layer comprising Pt-Pd at a 2:1 weight ratio and 75 g/ft³ loading supported on 5 wt.-% SiO₂—Al₂O₃.

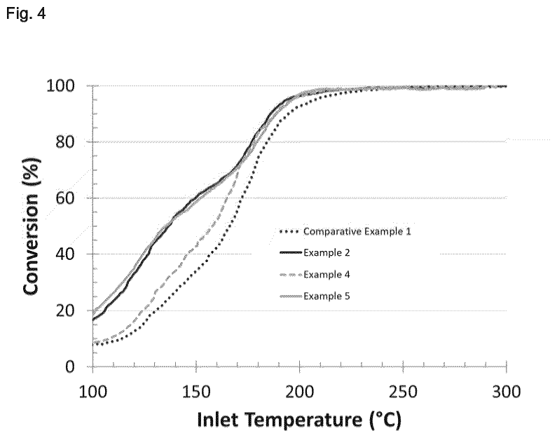

FIG. 5: shows formaldehyde (HCHO) oxidation performance after sulfation and 700° C. desulfation for the catalysts of Comparative Example 6 and Examples 7 and 8. All samples comprised a 2:1 Pt-Pd front zone at 75 g/ft³ and a rear zone comprising 10 wt.-% Mn, 10 wt.-% Ce and 10 wt.-% Cu supported on 9 wt.-% La₂O₃-stabilized ZrO₂. Additionally, the catalyst of Example 7 had a S-adsorbent layer comprising 9 wt.-% La₂O₃—Al₂O₃ coated over the Mn-containing catalyst layer in the rear zone while the catalyst of Example 8 had a S-adsorbent layer comprising 0.5 wt.-% Pt impregnated onto the 9 wt.-% La₂O₃—ZrO₂ prior to coating over the Mn-containing layer in the rear zone.

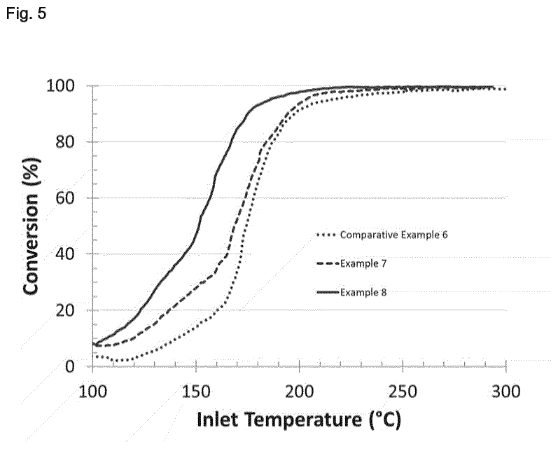

FIG. 6: shows formaldehyde (HCHO) oxidation performance after sulfation and 650° C. desulfation for the catalysts of Comparative Example 1 and Examples 2, 9 and 10. All samples comprised a 2:1 Pt-Pd front zone at 75 g/ft³ and a rear zone comprising 10 wt.-% Mn and 10 wt.-% Ce supported on 9 wt.-% La₂O₃-stabilized ZrO₂. Additionally, the catalyst of Example 2 had a S-adsorbent layer comprising 29 wt.-% Fe₂O₃—Al₂O₃ coated over the Mn-containing catalyst layer in the rear zone while the catalyst of Examples 9 and 10 had S-adsorbent layers comprising 10 wt.-% La₂O₃ supported on rare earth oxide doped CeO₂—ZrO₂ supports coated over the Mn-containing layer in the rear zone.

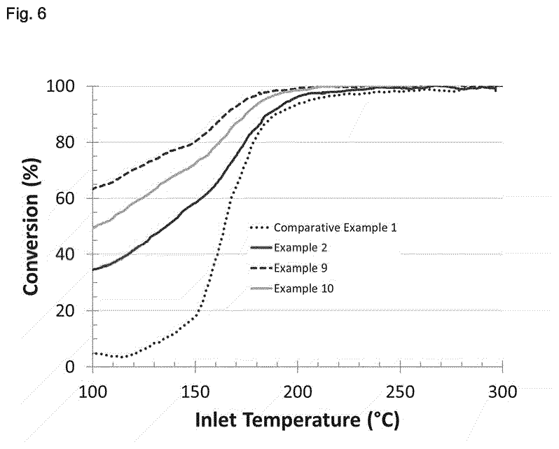

FIG. 7: shows formaldehyde (HCHO) oxidation performance after sulfation and 700° C. desulfation for the catalysts of Comparative Example 1 and Example 11. Comparative Example 1 comprised a 2:1 Pt-Pd front zone at 75 g/ft³ and a rear zone comprising 10 wt.-% Mn and 10 wt.-% Ce supported on 9 wt.-% La₂O₃-stabilized ZrO₂. Example 11 comprised the same zones as Example 1 except the orientation was reversed.

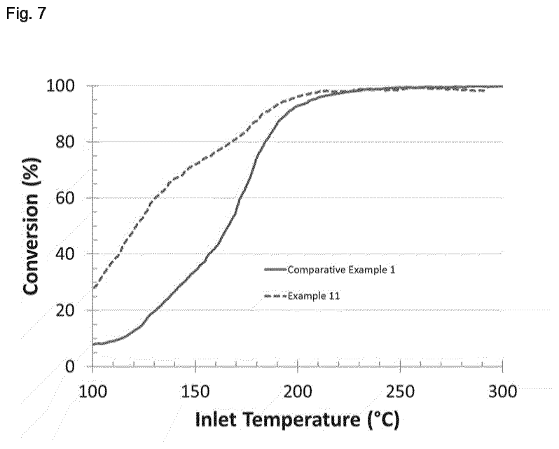

FIG. 8: shows HC slip results (given in ppm) measured downstream of the DOC sample during light-off testing of 1% diesel fuel on a lab reactor. Comparative Example 19 comprises only PGM while Example 2 and Comparative Example 6 comprise both PGM and BMO (base metal oxide).

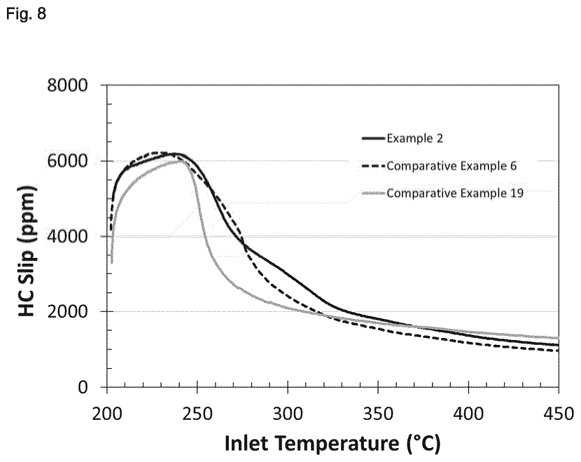

FIG. 9: shows exotherm results for Example 2 and only the Pt-Pd front zone of Example 2 tested by itself as measured downstream of the DOC sample during light-off testing of 1% diesel fuel on a lab reactor.

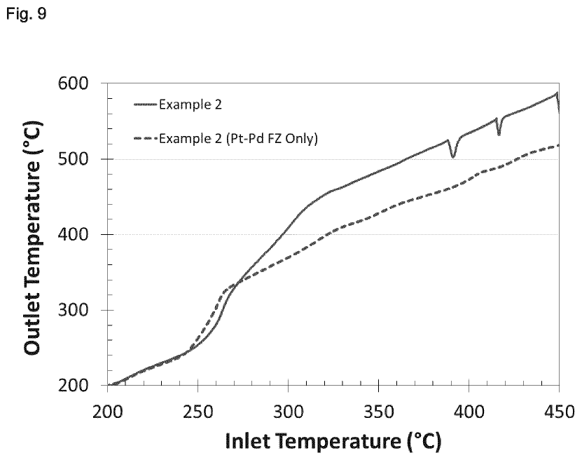

### CITED LITERATURE

WO 2022/047132 A1
U.S. Pat. No. 10,598,061 B2
U.S. Pat. No. 10,392,980 B2
US 2015/352493 A1
US 2022/152589 A1
CN112805089A

1. A catalyst for the treatment of an exhaust gas stream containing one or more of formaldehyde, nitrogen oxide (NO), and hydrocarbons, the catalyst comprising;
a first washcoat layer comprising Mn;
a second washcoat layer comprising a sulfur-trap material which may be desulfated, wherein the sulfur trap material comprises one or more metal oxides which react with SO₂ and/or SO₃ to form corresponding metal sulfites and/or sulfates, wherein the one or more metal oxides comprise oxides of Fe, wherein the loading of the one or more oxides of Fe in the second washcoat layer is in the range of from 15 to 65 wt.-%, calculated as Fe₂O₃ and based on 100 wt.-% of the second washcoat layer; and
a substrate,
wherein the substrate has an inlet end through which the exhaust gas stream may enter the catalyst, and an outlet end through which the exhaust gas stream may exit the catalyst, wherein the exhaust gas stream flowing through the catalyst first comes into contact with the second washcoat layer prior to coming into contact with the first washcoat layer,
wherein the catalyst further comprises one or more platinum group metals comprising Pt, Pd, or Pt and Pd, wherein the one or more platinum group metals are at least in part contained in one or more of:
(a) the first washcoat layer,
(b) the second washcoat layer,
(c) an optional third washcoat layer, or
(d) optional third and fourth washcoat layers.

2. The catalyst of claim 1, wherein the first washcoat layer comprises one or more of Ce and Cu.

3-5. (canceled)

6. The catalyst of claim 1, wherein the one or more platinum group metals are supported on a particulate support material.

7. The catalyst of claim 1, wherein the catalyst comprises a third washcoat layer, wherein the one or more platinum group metals are at least in part contained in the third washcoat layer.

8. The catalyst of claim 1, wherein the third washcoat layer comprises a hydrocarbon trap material, wherein the hydrocarbon trap material comprises a molecular sieve.

9. The catalyst of claim 1, wherein the catalyst displays a layered arrangement of the first and second washcoat layers, wherein the first washcoat layer is provided on the substrate, and wherein the second washcoat layer is provided on the first washcoat layer.

10. The catalyst of claim 1, wherein the catalyst comprises a third washcoat layer, wherein the catalyst displays a layered arrangement of the first, second, and third washcoat layers, and wherein the first washcoat layer is provided on the substrate, the second washcoat layer is provided on the first washcoat layer, and the third washcoat layer is provided on the second washcoat layer.

11. The catalyst of claim 1, wherein the catalyst displays a zoned arrangement of the first and second washcoat layers, wherein the second washcoat layer is provided on the substrate along its axial length starting from the inlet end of the substrate, and wherein the first washcoat layer is provided on the substrate along its axial length starting from the outlet end of the substrate, wherein the length of the first washcoat layer is less than the axial length of the substrate such as to create an upstream zone comprising the second washcoat layer and a downstream zone comprising the first washcoat layer.

12. The catalyst of claim 1, wherein the catalyst comprises a third washcoat layer,
wherein the catalyst displays a zoned arrangement of the first, second, and third washcoat layers, and
wherein the third washcoat layer is provided on the substrate along its axial length starting from the inlet end of the substrate, wherein the first washcoat layer is provided on the substrate along its axial length starting from the outlet end of the substrate, wherein the second washcoat layer is provided on and entirely covers the first washcoat layer, wherein the length of the first washcoat layer is less than the axial length of the substrate such as to create an upstream zone comprising the third washcoat layer and a downstream zone comprising the first and second washcoat layers, wherein the one or more platinum group metals are at least in part contained in the third washcoat layer.

13. An exhaust gas treatment system comprising an internal combustion engine and an exhaust gas conduit for exhaust gas from the internal combustion engine, wherein the exhaust gas conduit comprises the catalyst according to claim 1.

14. The exhaust gas treatment system of claim 13, wherein the system comprises one or more of an electric heater, a fuel burner, a fuel injector, a selective catalytic reduction (SCR) catalyst, an ammonia oxidation (AMOX) catalyst, a catalyzed soot filter (CSF), a diesel particulate filter (DPF), a selective catalytic reduction catalyst on filter (SCRoF), and a diesel exotherm catalyst (DEC).

15. A method for the treatment of an exhaust gas stream containing one or more of formaldehyde, nitrogen oxide (NO), and hydrocarbons, the method comprising;
(A) providing an exhaust gas stream comprising one or more of formaldehyde, nitrogen oxide (NO), and hydrocarbons;
(B) directing the exhaust gas stream provided in (A) through the catalyst according to claim 1.

16. A use of the catalyst according to claim 1 for the oxidation of one or more of formaldehyde, nitrogen oxide (NO), and hydrocarbons.
